(19) United States
(12) Patent Application Publication
(10) Pub. No.: US 2012/0310427 A1
(43) Pub. Date: Dec. 6, 2012

(54) Automatic Monitoring and Adjustment of a Solar Panel Array

(76) Inventors: B. Jeffery Williams, Austin, TX (US); Raymond A. Burgess, Austin, TX (US); Wilbur L. Dublin, III, Austin, TX (US); John W. Merritt, Driftwood, TX (US)

(21) Appl. No.: 13/478,230

(22) Filed: May 23, 2012

Related U.S. Application Data
(60) Provisional application No. 61/491,806, filed on May 31, 2011.

(51) Int. Cl. G06F 15/00; G06F 1/26

(52) U.S. Cl. 700/287; 702/189; 702/176; 702/182

(57) ABSTRACT

Automatically determining issues associated with a photovoltaic (PV) system. Information regarding the PV system may be stored. The information may include logical information regarding a logical configuration of the PV system and physical information regarding a physical layout of the PV system. Measurement data regarding the PV system may be received. The measurement data regarding the PV system may be automatically analyzed using the logical information and the physical information. An indication of any issues determined by said analyzing may be automatically provided.

### PRIORITY INFORMATION

This application claims benefit of priority of U.S. provisional application Ser. No. 61/491,806 titled “Automatic Monitoring and Adjustment of a Solar Panel Array” filed May 31, 2011, whose inventors were B. Jeffrey Williams, Raymond A. Burgess, Wilbur L. Dublin, III, and John W. Merritt, which is hereby incorporated by reference in its entirety as though fully and completely set forth herein.

### FIELD OF THE INVENTION

The present invention relates generally to solar power, and more particularly to a system and method for automatically determining issues for a solar system.

### DESCRIPTION OF THE RELATED ART

Photovoltaic arrays (more commonly known and referred to as solar arrays) are a linked collection of solar panels, which typically comprise multiple interconnected solar cells. The modularity of solar panels facilitates the configuration of solar (panel) arrays to supply current to a wide variety of different loads. The solar cells convert solar energy into direct current electricity via the photovoltaic effect, in which electrons in the solar cells are transferred between different bands (i.e., from the valence to conduction bands) within the material of the solar cell upon exposure to radiation of sufficient energy, resulting in the buildup of a voltage between two electrodes. The power produced by a single solar panel is rarely sufficient to meet the most common power requirements (e.g., in a home or business setting), which is why the panels are linked together to form an array. Most solar arrays use an inverter to convert the DC power produced by the linked panels into alternating current that can be used to power lights, motors, and other loads.

However, current solar array systems do not easily allow monitoring and adjustment of solar panel functionality. Accordingly, improvements in solar technology are desired.

### SUMMARY OF THE INVENTION

Various embodiments are presented of a system and method for automatically determining issues for a solar system.

Information regarding the photovoltaic (PV) system (also referred to as a “solar system” or “solar panel system” may be stored. The information may include logical information regarding a logical configuration of the PV system and physical information regarding a physical layout of the PV system. Additionally, the information may include information regarding characteristics of the components of the PV system. In some embodiments, various portions (or all) of the information regarding the PV system may be automatically obtained (e.g., from devices of the PV system).

Measurement data regarding the PV system may be received. For example, a computer system may receive the measurement data over a wide area network (such as the Internet). In one embodiment, the measurement data may be received by one or more servers (e.g., web servers or storage servers coupled to web servers) on the Internet.

The measurement data regarding the PV system may be automatically analyzed using the logical information and the physical information. For example, the method may store a model which describes a projected performance of the PV system based on the information regarding the logical configuration of the PV system, and the analysis may use the model. Alternatively or additionally, the method may store a model which describes a projected performance of the PV system based on the information regarding the logical configuration of the PV system and the physical layout of the PV system. In one embodiment, automatically analyzing may include comparing the received measurement data with an expected operation of the PV system. In another embodiment, automatically analyzing may include performing pattern matching to identify known patterns in the received measurement data regarding the PV system.

Automatically analyzing may also include comparing the received measurement data with statistical information of past measurement data to determine statistical outliers in the received measurement data regarding the PV system and/or to determine changes in the received measurement data. In some embodiments, automatically analyzing may include determining: 1) a rate of change (first derivative) of one or more parameters in the received measurement data and 2) a rate of rate of change (second derivative) of one or more parameters in the received measurement data.

Receiving the measurement data regarding the PV system and automatically analyzing the measurement data regarding the PV system may be iteratively performed. In one embodiment, the iterative data may be used to project system performance (e.g., at the panel level, string level, array level, etc.). Additionally, the analysis of data may include comparing the projected performance to actual performance.

An indication of any issues determined by said analyzing may be automatically provided. For example, the method may use a rules engine which provides rules for messaging alerts, and automatically providing an indication of any issues determined by said analyzing may be performed according to the rules engine. The rules engine may be configured to perform financial impact assessment based on value of energy and associated loss components detected within the PV system, a return on investment (ROI) analysis, and/or a payback time analysis utilizing cost of mitigation estimates, among other possibilities. Additionally, or alternatively, operation of the PV system may be automatically adjusted based on said automatically analyzing.

### BRIEF DESCRIPTION OF THE DRAWINGS

A better understanding of the present invention can be obtained when the following detailed description of the preferred embodiment is considered in conjunction with the following drawings, in which:

FIG. 1 illustrates an exemplary system, according to one embodiment;

FIGS. 2-7 are block diagrams illustrating interactions between exemplary logical blocks of the system, according to some embodiments;

FIG. 8 is a flowchart diagram illustrating one embodiment of a method for commissioning a solar system;

FIG. 9 is a flowchart diagram illustrating one embodiment of a method for aggregating measurement data of a solar system;

FIG. 10 is a flowchart diagram illustrating one embodiment of a method for analyzing aggregated data of a solar system to identify potential problems;

FIG. 11 is a flowchart diagram illustrating one embodiment of a method for acting on identified problems;

FIG. 12 is a flowchart diagram illustrating one embodiment of a method for acting measuring and analyzing power in a PV system;

FIG. 13 is an exemplary diagram corresponding to an embodiment of the method of FIG. 12;

FIGS. 14-16 are exemplary diagrams illustrating various embodiments.

FIG. 17 is an exemplary diagram corresponding to data flow in a PV system, according to one embodiment; and

FIGS. 18A-18F are exemplary diagrams corresponding to data visualization for a PV system, according to one embodiment.

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE INVENTION

### Terms

The following is a glossary of terms used in the present application:

Memory Medium—Any of various types of memory devices or storage devices. The term “memory medium” is intended to include an installation medium, e.g., a CD-ROM, floppy disks 104, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may comprise other types of memory as well or combinations thereof. In addition, the memory medium may be located in a first computer in which the programs are executed, or may be located in a second different computer which connects to the first computer over a network, such as the Internet. In the latter instance, the second computer may provide program instructions to the first computer for execution. The term “memory medium” may include two or more memory mediums which may reside in different locations, e.g., in different computers that are connected over a network.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

Automatically—refers to an action or operation performed by a computer system (e.g., software executed by the computer system) or device (e.g., circuitry, programmable hardware elements, ASICs, etc.), without user input directly specifying or performing the action or operation. Thus the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

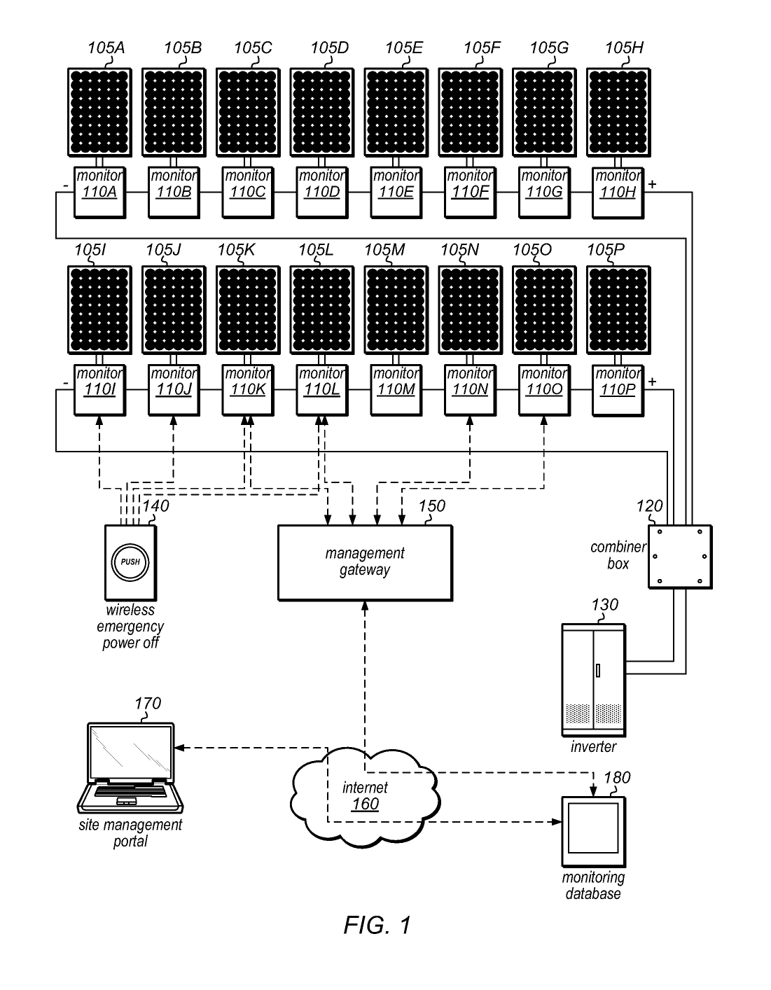

### FIG. 1—Exemplary System

In the exemplary system of FIG. 1, a plurality of solar panels are coupled to various devices, which may be configured to implement embodiments described herein. More specifically, a first string of solar panels 105 A-H and a second string of solar panels 105 I-P (forming a solar panel array) may provide DC power to combiner 120, which may in turn provide the power from the solar panel array to inverter 130, which may convert the provided DC power to AC power. The inverter 130 may provide the converted power to various power sinks (e.g., a power grid, a local system, such as a house or building, a battery system, etc.).

As shown, each solar panel 105 A-P may be coupled to a respective monitor 110 A-P. Each monitor may be configured to receive the DC power from each panel and provide the power to the combiner 120. As also shown, the monitors 110 may be coupled together in series (at least within each string of solar panels). Thus, each monitor 110 may receive power provided from its respective solar panel and add that power to the power of the other monitors within the string of solar panels. In some embodiments, the monitor 110 may provide power optimization functionality in order to optimize or improve the power provided from solar panel 105. In some embodiments, the monitors 110 may be referred to as “optimizers”.

In addition to receiving and providing power, each monitor may be configured to gather information regarding its corresponding solar panel. For example, the monitor 110 may store information regarding the received current, voltage, power, etc. of its respective solar panel 105. In addition to the electric properties of the solar panels, further information may be received for the solar panel 105. For example, the monitor 110 and/or solar panel 105 may include location circuitry (e.g., GPS circuitry) for determining the location of the solar panel 105. The solar panel 105 may further be configured to provide information regarding each of the cells of the solar panel. For example, the solar panel 105 may be configured to provide electric properties (e.g., current, voltage, power, etc.) of individual cells or groups of cells in the solar panel to the monitor 110. Further, the solar panel 105 may be configured to provide model or other identification information of the solar panel 105 (e.g., identifying the type of solar panel, such as by manufacturer, type, model number, serial number, etc.), any current attributes of the solar panel 105 (e.g., a current condition of the solar panel, such as damaged, dirty, functional, etc.), and/or any information pertaining to the solar panel 105 that may be of interest.

While the above describes the monitor 110 receiving or determining information regarding the solar panel 105 based on signals received from the solar panel 105, this information may be gathered or determined from sources other than the solar panel 105. For example, an external camera may be configured to monitor the solar panels 105. The external camera may provide images of the solar panels, or may perform image processing to determine whether the solar panel is currently shaded (e.g., from a nearby obstacle, such as a tree, building, etc.). Similarly, a temperature sensor may be used to measure the ambient temperature, the temperature of the respective solar panel, etc. The temperature sensor may provide such temperature information to the monitor 110, although in other embodiments, such information may be provided to other devices instead, as described below. Accordingly, the monitor 110 may receive information pertaining to its respective solar panel 105 from sources other than the solar panel 105. Note that the monitor 110 may include logic for performing any of the analysis described above, although in other embodiments, this intelligence may be performed elsewhere.

As shown, each of the monitors 110 may be coupled to wireless emergency power off 140. The monitors 110 may be coupled to the wireless emergency power off 140 via various wireless communication methods, such as Bluetooth, 802.11x (WLAN), WiMax, etc. A user may be able to shut down all or a subset of the solar panels 105 using the wireless emergency power off 140 via the monitors 110. In further embodiments, the solar panels may automatically be shut down, e.g., via the management gateway 150 or in response to other factors. In some embodiments, an emergency power shutdown may be performed at the PV module level (e.g., which is integrated into a wireless network interface gateway and/or supported by sensor nodes which incorporate an electrical or electronic disconnect switch). More specifically, a single gateway may be capable of initiating an entire PV system power shutdown command for the entire PV system. Finally, it may be possible to perform an emergency power shutdown using a device, e.g., issuing a PV system power ‘Safety’ shutdown command via a GUI.

In addition, the monitors 110 may be coupled to management gateway 150. Management gateway may be any kind of device that is configured to receive and store information provided by the monitors 110. For example, the management gateway 150 may be a computer system including a processor and a memory medium, storing programs that are executable by the processor. The management gateway 150 may instead (or also) be a router or modem that may be able to couple to and communicate with the Internet 160. Alternatively, the management gateway 150 may be coupled to a local area network (LAN), which is in turn coupled to the Internet 160 (e.g., via a router/modem). Each of the monitors 110 may provide information to the management gateway 150 regarding the solar panels 105.

As indicated above, in one embodiment, the management gateway 150 may include a memory storing programs that are executable by a processor of the management gateway 150. The programs stored in the memory medium may include monitoring programs for monitoring the information related to the solar panels 105 (e.g., as reported by the monitors 110 or other devices), analyzing programs for analyzing the gathered information, aggregating programs for aggregating the data gathered by the monitors 110 or other devices coupled to the management gateway 150, and/or other types of programs, as desired. In one embodiment, the management gateway 150 may host a website that may be accessible by various other computer systems (such as computer system 170) to view the gathered or generated data regarding the solar panels 105. However, in alternate embodiments described below, that website may be hosted by one or more servers on the Internet 160 (e.g., cloud computers coupled to the monitoring database 180), which a user may be able to access from any location.

The management gateway 150 may provide the information gathered or generated regarding the solar panels 105 (e.g., as reported by monitors 110, although other gathered information is envisioned) to monitoring database 180 over the Internet. The monitoring database 180 may store all or a subset of the data regarding the solar panels 105 in the database. For example, the monitoring database 180 may store time series data of the electric property information provided by the monitors 110 or any other type of data regarding the solar panels 105. The database 180 may store the data at almost any time scale. For example, the monitoring database may include electric properties of each of the panels 105 every 10 seconds, 30 seconds, 1 minute, 5 minutes, 10 minutes, 30 minutes, 1 hour, 5 hours, 1 day, etc.). Similarly, other information related to the solar panels 105 may be stored at various intervals in the monitoring database 108 (note that the intervals may vary depending on the type of data being reported). The management gateway 150 may store several sets of data before providing them to the monitoring database 180, provide the data as it is received from the monitors 110 or other devices, and/or provide data at a periodic rate (e.g., according to how often the data is stored in the database), etc.

The monitoring database may store information for a plurality of arrays of solar panels and/or for a plurality of different sites. For example, the monitoring database may have a table or identification associated with the site shown in FIG. 1. The monitoring database may have a separate table or identification associated with another site (which may be similarly configured). Thus, the monitoring database may include information associated with a plurality of different sites, which may be viewed by a plurality of different users, e.g., each associated with one or more sites, as desired.

One or more servers may be coupled to monitoring database 180. The servers may be configured to host a website so that users can view data associated with the solar panels at one or more sites. For example, a user or administrator associated with the site of FIG. 1 may be able to log in to the website to view information associated with that site's solar panels (or other information associated with the site). Other users may be able to view information associated with other site's solar panels. In alternate embodiments, rather than using a website, a client may execute an application which retrieves information from the monitoring database 180 (e.g., via the one or more servers) and provides the information in a graphical user interface of the application. Users may use any of various devices for viewing data associated with (or even managing) the solar panels 110 at the site. In the embodiment of FIG. 1, a user may use laptop 170 to access the site management portal provided by the servers for the site of FIG. 1. However, almost any type of device is envisioned for accessing the data associated with the site, such as cell phones, tablet computers, netbooks, laptops, desktop computer systems, etc. Generally, any type of device may be used to view information associated with the solar panels or even manage the solar panels at the site.

Thus, FIG. 1 illustrates an exemplary site and corresponding equipment at the site for implementing various embodiments described herein. Note that various ones of the devices shown in FIG. 1 may be combined, removed, or added. For example, the management gateway 150 may be combined with the combiner 120, the wireless emergency power off 140, the computer system 170, etc. In some embodiments, rather than reporting information to the management gateway 150, the monitors may report information directly to the monitoring database 180. Further, the monitoring database 180 may be included on site rather than over a wide area network, such as the Internet 160. Thus, multiple variations are envisioned for the exemplary system of FIG. 1.

In the following descriptions, the exemplary system of FIG. 1 may be used to implement the described embodiments.

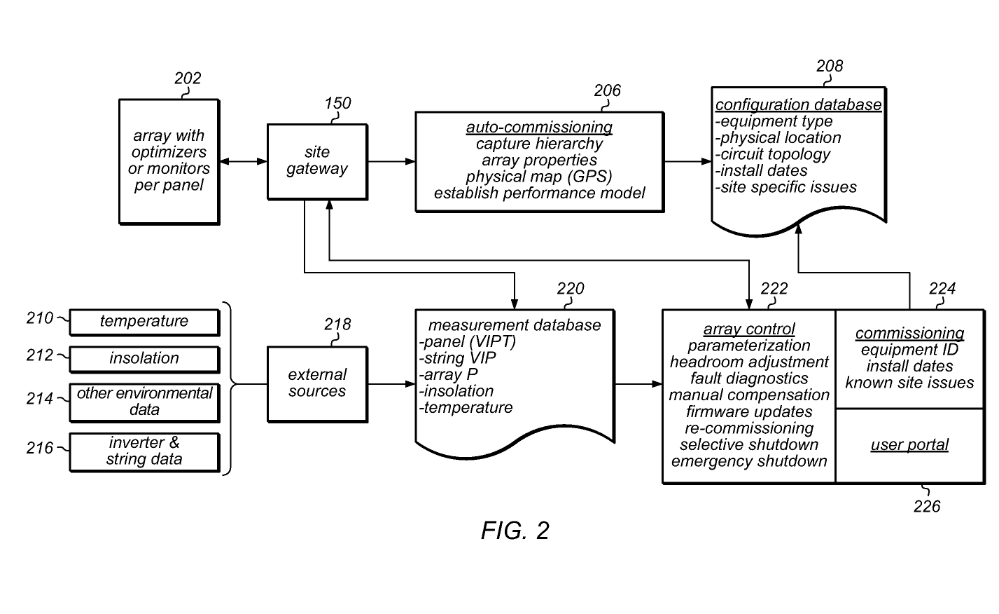

### FIGS. 2-7—Block Diagrams Illustrating Exemplary Operation

FIGS. 2-7 are block diagrams illustrating exemplary operation between various logical entities. The logical entities may be implemented by various ones of the devices shown in FIG. 1, among other possibilities. Additionally, note that while exemplary devices may be described for some of the logical blocks in the following, the logical blocks may be implemented by any of the devices described herein.

In FIG. 2, solar panel array with optimizers or monitors per panel 202 may be coupled to site gateway 150. More specifically, as shown in FIG. 1, each solar panel 105 may be coupled to the site gateway 150 via the monitors 110.

As also shown, auto-commissioning block 206 may receive information from the site gateway 150. Auto-commissioning block 206 may capture information, such as hierarchy (e.g., of the solar panels), array properties, a physical map of the solar panels or their locations (e.g., using GPS circuitry), and may be involved in establishing a performance model for the solar panel array. The auto-commissioning block 206 may gather the information indicated in 206 automatically, without manual user input specifying the gathered information. For example, the information may be gathered by the monitors 110 and/or other devices coupled to the management gateway 150. The auto-commissioning may be performed by the management gateway 150 and/or one or more servers, e.g., coupled to the monitoring database 180.

The gathered information may be stored in the configuration database 208. The configuration database 208 and the monitoring database 180 may be the same database or may be separate, as desired. For example, the configuration database 208 may be a portion of the monitoring database 180.

Thus, the information determined by the auto-commissioning block 206 may be captured and stored in the configuration database 208. Additionally, further input may be provided to the configuration database 208. For example, a user (such as a site administrator, solar panel technician or installer, etc.) may provide information that may be added to the configuration database via user portal 226 (e.g., via a website hosted by the one or more servers described above), such as equipment ID, install dates, known site issues (e.g., objects that may hinder operation of the solar system, such as objects that shade panels, among other possibilities), etc. Thus, the configuration database 208 may store equipment type information (e.g., of the solar panels, combiner, inverter, management gateway, etc.), physical location (e.g., of the site, the relative positions of the solar panels, the orientations of the solar panels, on site location information of the management gateway, combiner, inverter, etc.), circuit topology, install dates, and/or any other information, such as site specific issues (e.g., locations of trees that may obstruct insolation, etc.), which may be provided automatically and/or manually, as desired. Further details regarding commissioning are provided below.

In one embodiment, the configuration database 208 may store at least two types of data. For example, the configuration database 208 may store logical information related to the logical configuration of the solar system and physical information related to the physical configuration of the solar system. The logical configuration may specify the connectivity of the solar system (e.g., specifying each panel's connectivity, e.g., to its respective monitor, within its string, within its array, connectivity to a combiner, inverter, etc.). Thus, the logical configuration may specify the electrical configuration of the solar system. On the other hand, the physical information may specify the physical location of the panels, strings, arrays, etc. For example, the physical information may specify the GPS coordinates for each panel, how the panels are laid out, orientation (including angular orientation and directional orientation), etc. According to various embodiments, the logical information and/or physical information may be specified automatically and/or manually, in full, or in part. The configuration information may specify further information, such as any obstacles that may interfere with irradiation of the solar panels (e.g., a nearby tree, building, wall, etc.). This information may be included in the physical information indicated above. Other information may include the characteristics of the solar panels and equipment used (e.g., electrical properties of the panels, model numbers, etc.). The electrical properties of the panels and equipment may be included in the logical information.

As shown in FIG. 2, the site gateway 150 may provide information to the measurement database 220 (e.g., which may be the same as monitoring database 180 or different, as desired), such as the information gathered by the monitors 110 or other devices, e.g., on site. The measurement database may also receive information such as temperature information 210 (e.g., current ambient temperature, temperature at the location of the solar panels, etc.), insolation information 212, other environmental data 214, and inverter and string data 216, among other possibilities. Note that the external sources may be devices installed at the location (e.g., temperature sensors, cameras, other environmental sensors, etc.) or they may be gathered for the area in general (e.g., and retrieved over the Internet, such as from third parties). In addition, rather than the external sources providing the information directly to the measurement database 220, that information may be received or gathered by the site gateway 150 and provided to the database 220 in that manner. Thus, the management gateway 150 may aggregate all or some of the measurement information related to the solar system shown in FIG. 1.

Array control 222 may be coupled to both the site gateway 150 and the measurement database 220. Array control 222 may control and/or store parameters that may be used to define and adjust the performance of panels, monitors or optimizers in the array for the purpose of improving array performance. Array control 222 may also be used to instruct monitors and optimizers to provide detailed information on their status and performance as well as that of the panels to enable detailed fault diagnostics. Array control 222 may also be used to perform updates of the software programs stored in the monitors, optimizers, gateways or site servers, e.g., for the purpose of improving performance, adding new functionality, improving safety, comprehending the addition of new hardware in the array, or compensating for changed site conditions, such as when re-commissioning an array. The array control also enables selective shutdown of individual panels, strings, sections of and array or the entire array for the purposes of maintenance, repair or emergency shutdown, etc. In some embodiments, various ones of these functions may be performed automatically (e.g., by the one or more servers on the Internet 160) and/or manually (e.g., in response to user input to the user portal 226.

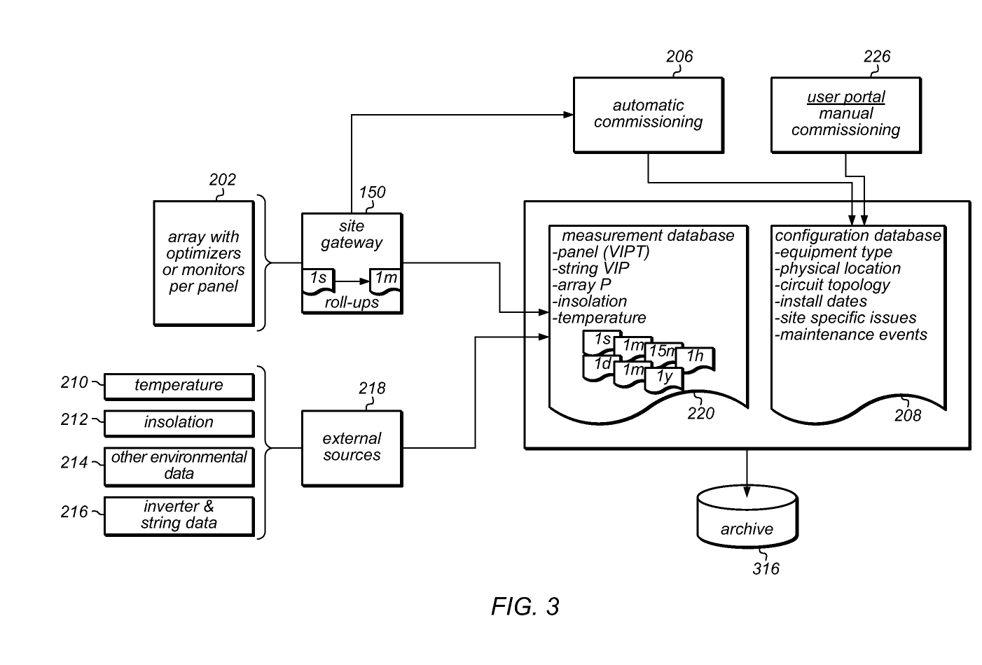

FIG. 3 illustrates a similar block diagram of FIG. 2 with some differences. As shown in FIG. 3, the array with monitors per panel 202 may provide information to site gateway 150. Site gateway 150 may aggregate sets of data provided from the monitors, e.g., with a set of data per desired interval. For example, the site gateway 150 may receive information from the monitors (or other devices) continuously, but may generate a set of data for every period (e.g., every second, 10 seconds, 15 seconds, 30 seconds, 45 seconds, 1 minute). These sets of data may then be provided to the measurement database 220, e.g., at a larger interval (e.g., every 1 minute, 5 minutes, 10 minutes, 15 minutes, 30 minutes, 1 hour, 1 day, 1 week, etc.). Similarly, information from external sources 218 may be provided to the measurement database 220.

As shown, the measurement database may store panel voltage, current, power and temperature values, string voltage current and power values, array power values, insolation values, temperature values, etc. and may include sets of data provided by the site gateway at various different intervals (e.g., 1 second, 1 minutes, 15 minutes, 1 hour, 1 day, 1 month, 1 year, etc.). The information in the measurement database may be backed up or stored in archive 316, which may be a cloud based storage system (e.g., one or more servers on the Internet that are configured to store information). In a similar fashion, the configuration database 208 may receive information automatically (via automatic commissioning 206) or manually (via manual commissioning using portal 226) and that information may also be backed up or stored in archive 316.

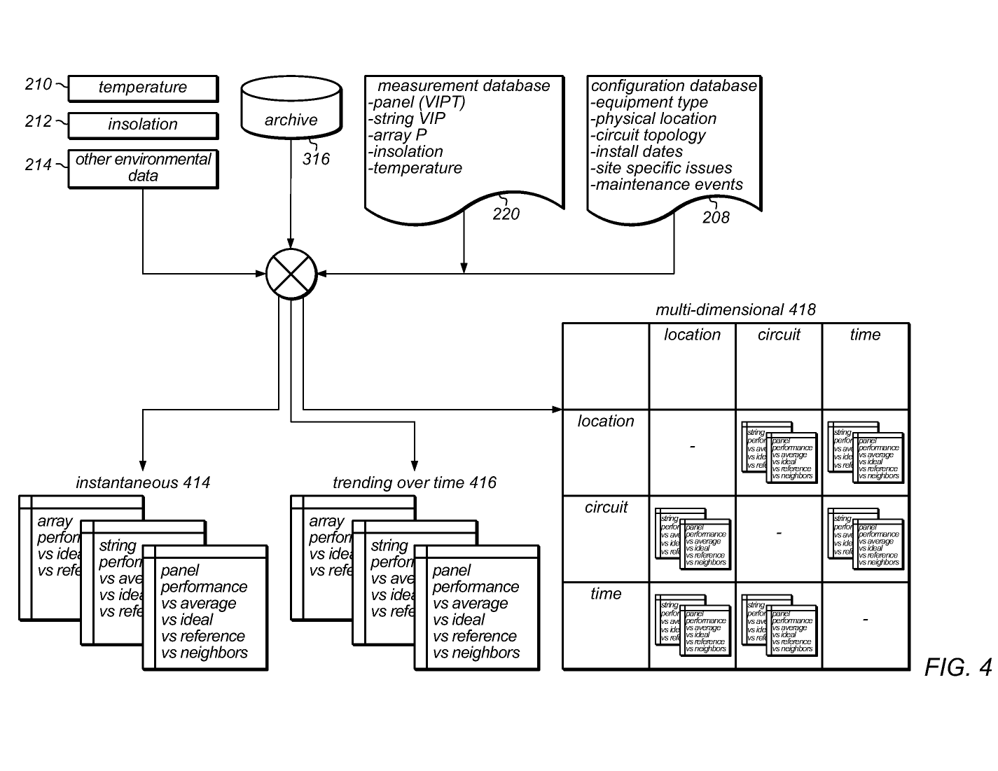

FIG. 4 illustrates a larger block diagram, building on the embodiments of FIGS. 2 and 3. As shown, the database 220 and 208, the archive 316, and the external source information (e.g., temperature 210, insolation 212, and other environmental information 214 such as wind speed and direction) may be used to build instantaneous information 414 and trending over time information 416. For example, the instantaneous information 414 may indicate individual panel, string, and/or array performance versus average, ideal, reference, neighbors, etc. Similarly, the trending over time may indicate the values of these factors or attributes over time (e.g., using a graph). Note that in some embodiments, the external information shown in FIG. 4 may be included in the measurement data; however, some external data may be gathered from external data sources that are accessible to analysis and diagnostic tools that are not normally included in the measurement database (e.g., web hosted weather data indicating that snowfall has occurred which may be obscuring the sun from the array, etc.).

Multi-dimensional information 418 may be generated based on the databases, archive, and external information, such as the attributes discussed above relative to location versus circuit, location versus time, circuit versus time, etc. More specifically, the multi-dimensional information 418 may represent the data that is generated and/or analyzed to identify potential problems. The location and circuit information may be stored in the configuration database (e.g., as physical information and logical information) and the time information may be stored in the measurement database (e.g., representing previously stored values for panels, strings, arrays, etc.).

In one embodiment, the electrical properties of various panels may be compared against the location of those panels in circuit versus location. This comparison may allow for a pattern to be recognized (e.g., that a certain portion of the array is shaded). As another example, the electrical properties versus previous electrical properties (the time factor) may allow a pattern or problem to be identified. For example, there may not be a problem if the panel output is lower at a certain time of the day. However, where the panel is typically at a certain level (as determined by previous data), but is not currently at that level, a problem may be identified (e.g., there may be an issue with the panel or associated string). Further details regarding identification of problems using multi-dimensional data are provided below.

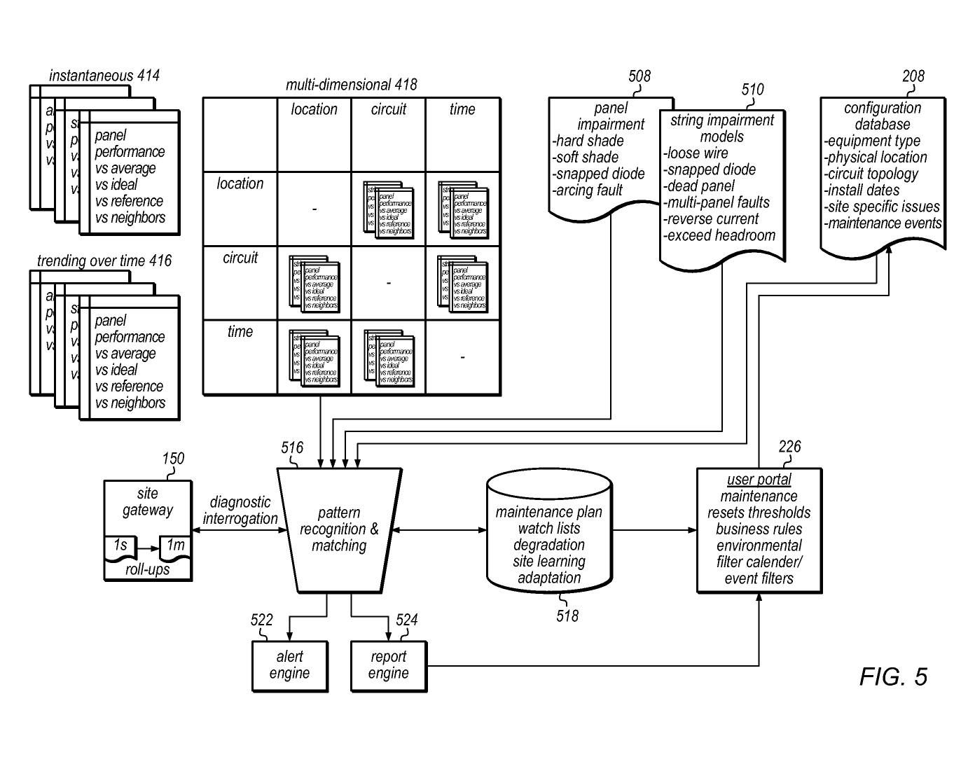

As shown in FIG. 5, a subset or all of this information may be used for pattern recognition and matching, among others. For example, a portion or all of the instantaneous information 414, the trending information 416, the multi-dimensional data 418, the information stored in the configuration database 208, as well as various models may be used to perform the pattern recognition and matching in block 516 (e.g., which may be performed by the one or more servers on the Internet 160). The models may include panel impairment models 508 (e.g., incorporating models for hard shade, soft shade, snapped diode, arcing fault, etc.) as well as string or array impairment models 510 (e.g., loose wire, snapped diode, dead panel, multi-panel faults, reverse current, exceed headroom, etc.). Further models may include ideal or expected operational models (e.g., which may generally return the expected values for the panels, strings, array(s) etc.). These models may provide expected values based on the specifications or types of panels and equipment used (e.g., which may be specified in the configuration database) and/or based on the behavior reported from the site (e.g., based on the performance recorded initially, before any physical impairments were caused, or over an average of the performance of the solar system).

The pattern recognition and matching block 516 may use the gathered information and various models to determine if there are any problems or issues to resolve for the array of panels shown in FIG. 1. In determining the current information (e.g., such as problems or solutions to determined problems), the pattern recognition and matching block 516 may interrogate the management gateway 150 to retrieve diagnostic information. Any problems identified by block 516 may be provided to alert engine 522 (e.g., for alerting one or more users of a problem, current condition, solution, etc.) and/or report engine 524, which may report that determined information to the user portal 226. Block 516 may also be coupled to database 518 which may store information regarding maintenance plan(s) for the solar system (e.g., the panels, the inverter, the combiner, the management gateway), watch lists (e.g., for possible failure of a piece of equipment), degradation, site learning/adaptation, etc. The database 518 may also be coupled to the user portal 226. In some embodiments, block 516 may provide information to an adjustment block which operates to adjust parameters or characteristics of the panels to correct detected problems.

As shown, the user portal 226 may include information (e.g., for display to the user) concerning maintenance, resets (e.g., of alerts), thresholds (e.g., which may be modified by the user), business rules, environmental filter or calendar event filters, etc. For example, the user may specify thresholds before any issues are reported (e.g., 2% of expected output), thresholds before any maintenance is performed (e.g., expected gain in threshold exceeds a threshold amount, if the expected cost is less than a threshold amount, if the difference in gain and cost is above a threshold, etc.). For example, one rule may specify that a maintenance routine should not be performed for an identified issue if the cost is 450 dollars and the annual benefit is 200 dollars. As another example, damage to a portion of a panel may not warrant replacing the entire panel (or fixing the current panel), given the cost of the replacement or repair of the panel versus the benefit.

A user may also specify or modify other filters or conditions for notifications. For example, a user may specify that a portion of the solar array that may be shaded in the afternoon by a physical obstruction (e.g., a building, tree, etc.) should not set an alarm. As another example, where there was a large amount of snow fall the previous night (e.g., as detected by sensors, gathered from weather reports available online, etc.), the user may specify not to be notified of low system wide performance (since the panels are likely covered with snow). Thus, the user may control various parameters, thresholds, rules, etc. for maintaining the solar system, e.g., in response to the issues identified by block 516.

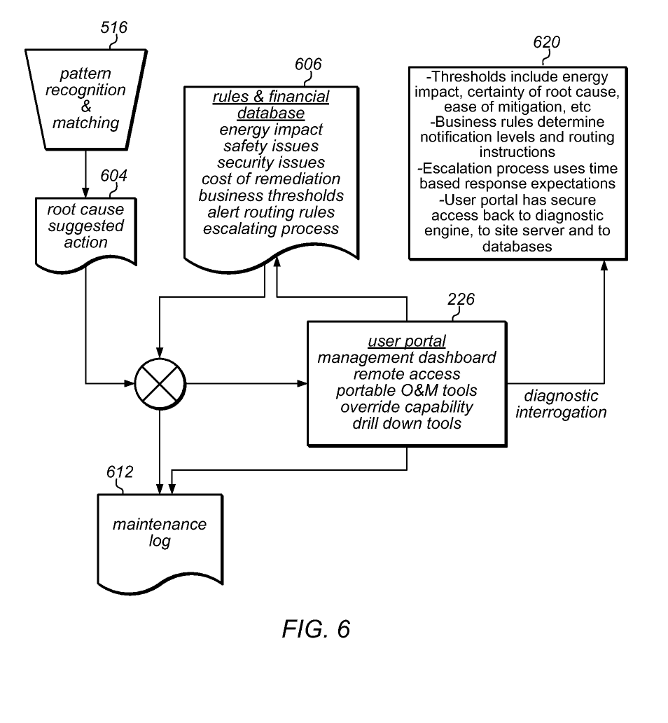

FIG. 6 illustrates further details regarding the use of block 516. As shown, pattern recognition and matching block 516 may provide a root cause or suggested action (e.g., for overcoming an identified problem) in 604. The rules and financial database 606 may be involved in determining how the problem and potential solution is handled. For example, the rules and financial database 606 may deal with energy impact, safety issues, security issues, cost of remediation, business thresholds, alert routing rules, escalating process, etc. to determine how the problem or potential solution should be handled. More specifically, the database 606 may include thresholds such as energy impact, certainty of root cause, ease of mitigation, etc. The business rules may determine notification levels and routing instructions. The escalation process may use time based response expectations. The rules database 606 and the identified cause or suggested action 606 may both be used to determine what is provided to the user portal 226 and/or the maintenance log 612.

For example, the user portal 226 may provide a management dashboard with remote access, portable O&M (operation and maintenance) tools, override capability, and drill down tools to evaluate the current rules, the identified problem, and the suggested action to overcome the identified problem. For example, the rules 606 may be used to determine whether the suggested action should be performed automatically. However, a user may use the user portal 226 to evaluate the current issue and/or suggested action (e.g., to override the automatic choice), change the rules in 606, view more details, etc. In addition, the user portal may have secure access back to diagnostic engine, to site server, and/or to databases to perform more detailed analysis of the identified root cause or suggested action. Thus, the suggested action may be performed automatically and recorded in the maintenance log or may be performed manually (e.g., if the suggested action cannot be performed automatically, or if the user chooses to override the automatic declination of the suggested action, etc.) and recorded in the maintenance log.

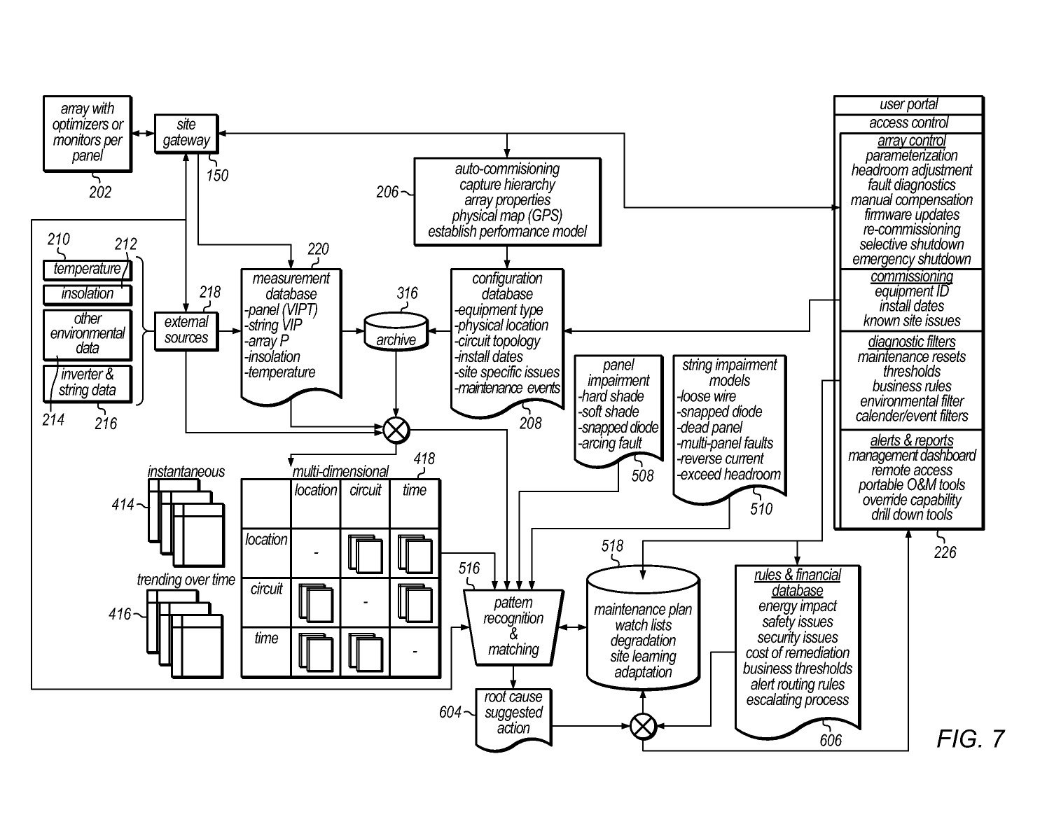

FIG. 7 illustrates a combined diagram showing the combination of the previous block diagrams 2-6. As shown, all of the gathered information, models, identified causes and remedies, rules, etc. may be used to identify and address issues of the solar system of FIG. 1. In addition, the user portal 226 includes a variety of interfaces and capabilities for a user associated with the solar system. For example, the user may have access to array control, commissioning, diagnostic filters, alerts and reports, etc.

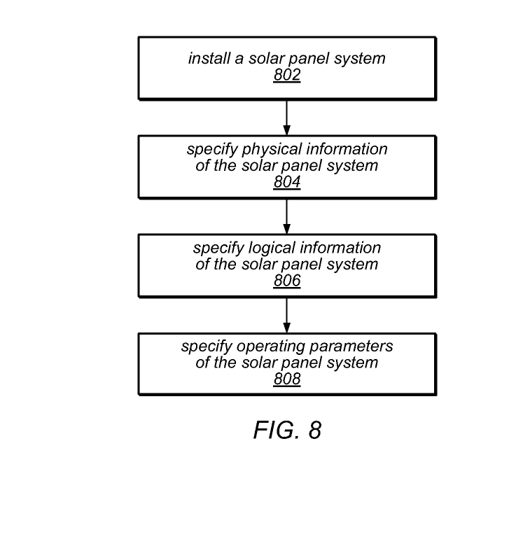

### FIG. 8—Commissioning a Solar System

FIG. 8 illustrates a method for commissioning a solar system. The method shown in FIG. 8 may be used in conjunction with any of the computer systems or devices shown in the above Figures, among other devices. For example, FIG. 8 may correspond to an embodiment of a method performed by the various commissioning blocks shown in FIGS. 2-7. In various embodiments, some of the method elements shown may be performed concurrently, in a different order than shown, or may be omitted. Additional method elements may also be performed as desired. As shown, this method may operate as follows.

In 802, a solar system may be installed at a site. For example, a solar system such as the one shown in FIG. 1 may be installed.

In 804, physical information of the solar system may be specified. The physical information may include a physical layout of the solar panels. For example, the physical information may specify the physical location of each of the solar panels. In one embodiment, the physical location may be specified as GPS coordinates. Alternatively, or additionally, the physical location of the panels may be specified in a relative manner, such as to each other (e.g., panel 1 is the top left panel, panel 2 is the panel to the right of panel 1, etc.), relative to the site (e.g., relative location on the roof of the site), etc. In some embodiments, the physical information (e.g., the physical layout) may be specified as a map, or may be specified in a manner that allows for visualization of the physical layout in an image (e.g., within an vector graphics file that may be specified in a markup language, such as XML). Thus, the physical information may indicate the locations of the panels at the installation site.

The physical information may specify other information as well. For example, the physical information may be used to specify the location of the installation site (e.g., location on the globe, which may be useful for determining other information, such as desired solar panel angles, weather information, etc. The physical information may also specify the current angle of the panels. In general, the physical information may specify any information related to the physical characteristics of the panels, as opposed to the logical (or electrical) connections described below.

The physical information may also specify any site issues or possible obstructions to the irradiation of the solar panels. For example, the physical information may specify the location of an obstruction to irradiation, such as a tree, building, wall, etc. As described below, this information may be used to filter out known issues from possible new issue (since these identified obstructions are expected to cause a decrease in output for some of the solar panels).

The physical information may be specified automatically and/or manually. For example, a user may specify all or a portion of the physical layout of the solar panels, locations or presence of obstructions, angles of the solar panels, etc. In one embodiment, a user may use an interface (e.g., of an application, of a website hosted by the one or more servers described above, etc.) to specify the various physical information.

However, in some embodiments, various portions (or all) of the physical information may be determined automatically. For example, each solar panel (or corresponding monitor) may include GPS circuitry which may report the location of the solar panel (e.g., with a corresponding solar panel ID) to the configuration database (e.g., via the gateway at the site). Solar panels may also have the ability to report current angle information, e.g., via an angle sensor, such as a level.

In some embodiments, this information may be gathered in response to user input or with the help of a user. For example, a user may have a device (e.g., a smart phone) which executes an application to assist in specifying the physical information. For example, a user may place the device on each panel and the device may gather information regarding the panel (e.g., the location, by using GPS circuitry, the angle, by using a level sensor, the identity of the panel, by using a barcode scanner or RFID device, among other possibilities, etc.). Thus, the user may assist in the gathering of the information (e.g., by executing an application of a device) and the device may automatically gather the desired information. The device may synch to the configuration database in various manners (e.g., via wired or wireless fashions, local area networks, wide area networks, etc.). Thus, physical information of a solar system may be specified in a manual and/or automatic fashion, as desired.

In 806, logical information of the solar system may be specified. The logical information may specify the connectivity (e.g., the electrical connectivity) between the various devices of the solar system at the site. In one embodiment, the logical information may specify how every device is connected in the solar system. For example, the logical information may specify the series (including order) of panels and monitors/optimizers within a string, the number of strings that are connected to a combiner, the strings in an array, the connectivity to the inverter, etc. The logical information may also specify the types of each device and associated characteristics. For example, the logical information may identify each solar panel's electrical characteristics (e.g., supplied voltage, current, etc.), the model number of each solar panel, etc. Similarly, characteristics of each of the other devices may also be stored, e.g., for the monitors, combiners, inverters, management gateway, etc.

Similar to above, the logical information may be specified automatically and/or manually. For example, a user may specify the electrical connectivity information, device type information, etc. using a user interface (e.g., of an application, webpage associated with the installation site, etc.). Alternatively, or additionally, all or a portion of the logical information may be gathered and reported automatically. For example, each monitor may be configured to query its corresponding solar panel for the characteristics (or other information) associated with the solar panel. Accordingly, the solar panel may provide that information, and the monitor may in turn provide the gathered information for storage in the configuration database (e.g., via the management gateway). The gathered information may indicate the identity of the monitor and/or solar panel with which the information is associated. One or more (or all) of the devices may be configured to determine their respective location within the connections to the inverter (or other devices). For example, each device may include logic for determining which position it is within a string, within an array, etc. and that information may also be reported. Thus, all or a portion of the logical information may be gathered automatically and/or manually, as desired.

In 808, operating parameters of the solar system may be specified. The operating parameters may include the open circuit and maximum power point voltage of the individual panels in the array, as well as the short circuit and nominal maximum power point current at a defined operating temperature and irradiance level. The operating parameters may also include power output levels for each panel, each string and each sub-array output at the combiner box or inverter level. In some embodiments, the operating parameters may include desired maximum and minimum string current levels, or maximum and minimum string voltages.

One or more of the operating parameters may be automatically determined based on the logical information and/or physical information specified in 804 and 806 above. Alternatively, or additionally, the operating parameters may be specified manually, although any combination of manual or automatic determination of the parameters are envisioned. As an example, a system may be designed with a maximum limit on the desired string current, which may be provided manually as a parameter which may control optimizers installed in the array. In contrast, the open circuit string voltage presented by a panel at start-up is a parameter defined by the physics of each panel and can be measured automatically by monitoring devices within the array.

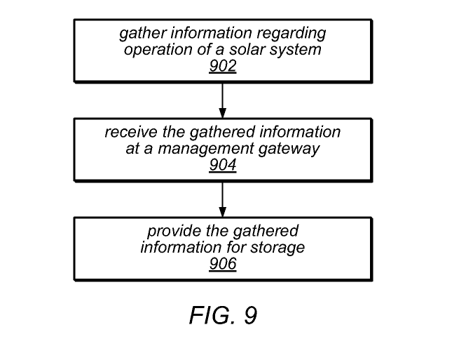

### FIG. 9—Gathering Measurement Data

FIG. 9 illustrates a method for aggregating measurement data of a solar system. The method shown in FIG. 9 may be used in conjunction with any of the computer systems or devices shown in the above Figures, among other devices. For example, FIG. 9 may correspond to an embodiment of a method for populating the measurement database shown in FIGS. 2-7. In various embodiments, some of the method elements shown may be performed concurrently, in a different order than shown, or may be omitted. Additional method elements may also be performed as desired. As shown, this method may operate as follows.

In 902, information regarding operation of a solar system may be gathered from a plurality of devices. The information may be gathered at any of a plurality of levels. For example, the information may include per panel information (e.g., electrical properties regarding operation of each panel), per string information (e.g., electrical properties regarding operation of each string), and/or per array information (e.g., electrical properties regarding operation of each array), among other possibilities. For example, the information may specify voltage, current, and/or power output for each panel, each string, each array, etc. The information may also contain panel temperature, ambient temperature, irradiance, wind speed and direction data as well as time and date. In some embodiments, the information may be generated or measured by the monitors 110 described in FIG. 1 (e.g., where each monitor provides respective electrical information regarding its corresponding solar panel). Additionally, other types of data may be generated, such as temperature information of each solar panel (or associated with each monitor).

However, other sources may provide the information. For example, information may be generated or measured by combiners, inverters, etc. In further embodiments, devices other than those involved in the solar panel array may generate measurement data. For example, there may be temperature sensors for measuring the ambient temperature near the solar system, irradiance meters for measuring the strength of the incident light, cameras for taking pictures of portions or all of the solar system (e.g., for image analysis, such as to determine if the panels are soiled, determining shadow patterns on the solar panel array, determining temporary obstructions (e.g., snow, dead bird, etc.). Thus, in addition to the information generated by devices in the solar panel array, external sensors may provide measurement data.

In further embodiments, measurement data may be gathered from external sources. For example, current, future, or past weather conditions may be gathered from servers on a wide area network (e.g., from a website on the Internet). Such sources may indicate whether or not a large snow storm occurred recently, the current temperature near the solar panel array, the current pollen count (e.g., which may soil the solar panels), etc.

The information may be gathered or generated at continuously, at various intervals, or in response to various stimuli. For example, the monitors may generate measurement data continuously and store the measurement data in a local memory of the monitor. Alternatively, the monitors (or other devices generating measurement data) may only store the measurement data periodically (e.g., every 500 ms, 1 second, 2, seconds, 5 seconds, 10 seconds, 30 seconds, 1 minute, 10 minutes, 15 minutes, 30 minutes, 1 hour, etc.). In some embodiments, the devices may generate data in response to stimuli (e.g., only generating or storing data when values are changed, e.g., by a threshold amount).

Note that some devices may generate data at different rates than other devices. For example, the electrical property information of the panels, strings, arrays, etc. may be generated at a rate that is faster than the current temperature information, weather information, photographs, etc. In general, the data that is most important and/or changes most often may be gathered more often that other data.

In 904, the gathered information may be received by a management gateway. For example, each monitor may provide the generated data to the management gateway periodically. In some embodiments, the information may be provided at the rate of storage indicated above, or may be provided in sets. For example, the monitors may gather information every second, but may only provide the information to the management gateway every 10 seconds, with 10 sets of data (one for each second). Alternatively, the information may simply be provided to the management gateway continuously, as the measurement data is generated. The management gateway may also be configured to retrieve the information from other sensors or external sources (e.g., over the Internet); however, in alternate embodiments, that information may be gathered by other servers which may provide the information for storage in 906, separately from the management gateway. Thus, the management gateway may receive all or a portion of the measurement data, as desired.

In 906, the management gateway may provide the gathered information for storage, e.g., in a measurement database. For example, the management gateway may provide its received information to a measurement database that is hosted by one or more servers on the Internet. Similar to 904 above, the management gateway may provide the information as soon as it is received, or in sets of data, e.g., provided at a slower rate. For example, the management gateway may receive measurement data from each of the monitors every 1 second, but may only provide the information for storage every 1 minute, 5 minutes, 10 minutes, 30 minutes, 1 hour, 2 hours, 24 hours, etc. with corresponding sets of data. In some embodiments, the one or more servers may request data with at a certain interval (e.g., data for every 5 minutes rather than the stored data at every 1 second), and the management gateway may provide the data at that specified interval.

In further embodiments, the management gateway and/or database may be omitted or combined, as desired. For example, the information may be provided for storage in a database over a wide area network without using the management gateway. Alternatively, the management gateway may store all of the received information locally (e.g., except for using a backup service which may store a backup of the information at an external location). Thus, while the method of FIG. 9 describes both the management gateway receiving the information and providing the information for storage at another location, one or more of these steps may be omitted or combined.

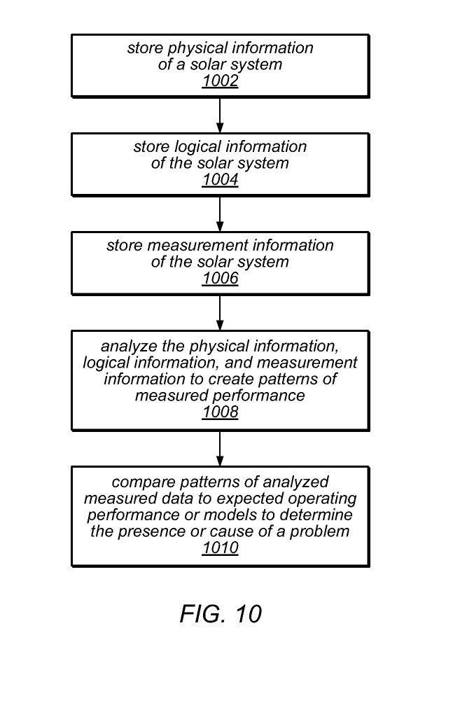

### FIG. 10—Identification of Potential Problems

FIG. 10 illustrates a method for identifying potential problems in a solar system. The method shown in FIG. 10 may be used in conjunction with any of the computer systems or devices shown in the above Figures, among other devices. For example, FIG. 10 may correspond to an embodiment of the pattern recognition and analysis blocks shown in FIGS. 2-7. In various embodiments, some of the method elements shown may be performed concurrently, in a different order than shown, or may be omitted. Additional method elements may also be performed as desired. As shown, this method may operate as follows.

In 1002, physical information of a solar system may be stored, and, in 1004, logical information of a solar system may be stored. For example, the physical and logical information may be stored during a commissioning process, such as described with regard to FIG. 8. However, the physical and/or logical information may be stored at other times as well (e.g., during a re-commissioning of the solar system, after maintenance or upgrades are performed, etc.).

In 1006, measurement information of the solar system may be stored. For example, the measurement information may be stored as described above regarding FIG. 9.

In 1008, the physical information, logical information, and measurement information may be analyzed to automatically create patterns of measured performance for individual panels, strings, or logical or physical zones in the array, instantaneously, or trended over defined time periods such as an hour, a day, a week, a month, a year. These patterns of data may be normalized across the array using averaging, referenced to physical information in the configuration database, or normalized with respect to irradiance level, or temperature.

In 1010, the patterns of analyzed measured data are compared to expected operating performance or models of known impaired performance due to faults in the panels, strings or array, to determine the presence or potential cause of a problem (or potential problem) in the solar system. In the discussions herein, while the term “problem” or “issue” is used, the identified “problem” or “issue” may also be a potential “problem” or “issue”. For example, the method may determine that low power output from one or more panels is caused by soiling, the reality may be different. Additionally, the method may identify that the source of the identified problem is shading from a known object, accordingly, it may not actually be an issue to be addressed, since it is already known. Thus, the identified problem may or may not actually be a problem. Regardless, the problem or potential problem may be determined via a variety of different processes.

In some embodiments, the analysis of the physical information, logical information, and measurement information to determine the problem may be determined using heuristics. For example, various thresholds and comparisons may be used (e.g., comparing current electrical information against past information or array averaged information, determining whether solar panels are in the same area as others with lower power outputs, determining whether solar panels are within the same string as others with lower power outputs, etc.), which may have been determined by developers of the analysis engine and/or may be automatically determined (e.g., via an adaptive learning system). For example, the heuristics may include a series of comparisons that are used to select a variety of different analyses.

As one example, a solar panel's output may be compared against the current solar panel output average to determine if the solar panel is underperforming or not, e.g., by a threshold amount. In the case that it is, further analysis may be required (e.g., comparing the current panel against the average of the string to determine whether it is localized to the panel or to the string or comparing the current panel against the average of nearby panels to determine whether the issue is localized to the panel or the location of the panel). Such processes may be applied to strings, arrays, etc. using any combination of the measurement data (present or past), the logical information, and/or the physical information.

For example, all solar panels in a certain area (e.g., determined using the physical information) are lower than the average of the other panels in the array (e.g., determined using the current measurement data), the method may determine that there is an obstruction. The method may further analyze the physical information to determine that there is a nearby object (such as a tree or building) that could block that area and may also use other information such as time of day, location of the sun in the sky relative to the solar panels (e.g., using location information of where the panels are located), etc. Accordingly, the method may realize that there is not an issue since the shading is coming from a known object. However, where no object is known, the method may flag the phenomenon as a potential problem to be addressed. In further embodiments, the method may compare the current data with previous data at the same time of day to determine if the problem consistently occurs at that time of day. Thus, if the problem typically occurs at the same time every day, it may not be an issue; however, if it is an anomaly, then the method may flag it for further inspection or notify a user, as described below.

As another example, several solar panels in a same string may output less than the average of the array. Accordingly, analyze the output against the physical information to determine if the problem could be location based, or simply related to the logical connection of the solar panels (e.g., by determining that the solar panels are in the same string). Similarly, the method may analyze prior history data of the panels to determine if there is a pattern of the lower output. Based on further analysis of the prior history data, the method may determine that there is likely a loose wire or faulty connection in the specific string that the solar panels are in.

In a further example, a single solar panel may suddenly begin to output 20% less power than normal or than is expected by the type of panel (e.g., as specified by the stored characteristics of the panel). The method may analyze logical information to determine if the issue is based on connectivity of the panel, physical information to determine if the issue is based on location (e.g., of the panel or other known objects), prior measurement data to determine if the issue is recurring, etc. Upon determining that the condition is sudden and not related to other known factors, the method may determine that a portion of the panel is likely faulty or broken. Similar analyses as above may be used for other statistical information of past performance, e.g., based on peak performance of a

[symbol]

Thus, in the examples above, the method may compare current information against other data to determine the issue, e.g., the previous data in the measurement data, the connectivity information in the logical information, the location information in the physical information, etc. More specifically, the method may compare each set of data against each other to determine the problem (e.g., a likely cause to the identified shortfall in power output by a panel, string, array, etc.). Thus, the method of FIG. 8 may particularly use the multi-dimensional data 418 to perform pattern recognition and matching 516, as mentioned in descriptions regarding the pervious Figures.

Additionally, or alternatively, the method may use various different models to determine the issues. In one embodiment, the models may include optimal or expected behavior of various panels or strings. For example, there may be an expected output of each panel based on the characteristics or type of the panel (e.g., a certain type of panel may be expected to generate a certain level of power based on the characteristics of the panel). Alternatively, there may be an expected output of each panel based on the observed output of the panels, e.g., the observed output after installation when most or all issues have not yet occurred, such as soiling or malfunctions, etc., or under typical or optimal operating conditions (e.g., a sunny day, cloudy day, etc.). Further the expected output (e.g., as indicated by a model) may be based on previous impairments or known impairments of the PV system (e.g., individual panels, strings, arrays, etc.). Thus, models may be used to determine whether to perform further analysis (e.g., for providing a comparison for the current data).

As another example, the method may use various impairment models which indicate the output of panels or strings under various conditions (e.g., for a snapped diode, hard shading, soft shading, arcing fault, loose wire, dead panel, multi-panel faults, reverse current, excess headroom, etc). Accordingly, the method may be able to compare the current and/or past measurement data with the expected output of the impairment models to determine the likely cause of the observed issue.

In a further example, the method may use a degradation model to determine if the current output (e.g., which may be identified as a problem) matches the expected degradation of a solar panel. For example, a solar panel may be expected to reduce its output according to a certain schedule (e.g., as represented by the degradation model), and accordingly, the current output of the panel, while lower than previous outputs, may be expected. Accordingly, the solar panel's lower output may be either identified as actually a problem (since it may be at a level of degradation to necessitate replacement) or not (since the degradation was expected).

In one embodiment, pattern matching may be used to identify known patterns in received measurement data (e.g., using any of the models and/or heuristics described above). The pattern matching process may include the use of logical information to normalize groups of related data for detection of anomalous operation. Further, electrical connectivity information associated with the logical configuration information may be used to infer new data based on data that has already been measured. This inferred data may be analyzed to estimate potential anomalies in the portions of the PV system which are not directly monitored or to enhance the identification of anomalies in the PV system. Additionally, the pattern matching may include statistical filtering of the data for analysis and identification of anomalies.

In some embodiments, during the analysis the method may query various databases or devices for information to assist in the analysis. For example, the method may interrogate the site gateway, the measurement database, the configuration database, etc. to retrieve diagnostic information that may be required to perform the analysis. For example, previous weather data may be used to determine that all of the panels are likely covered in snow since it snowed heavily the previous day or night. Accordingly, the method may identify this as a problem (e.g., to clear the snow off of the panels) or not (e.g., since it will melt), depending on the embodiment.

In some embodiments, some of the solar panels or identified problems may be placed on a “watch list”, e.g., before they are acted upon. For example, while the method may identify that a panel is experiencing a snapped diode, the method may not immediately act on that conclusion (e.g., by reporting it to a user, requesting maintenance, etc.). Instead, the method may place the panel or specific issue on a watch list so that the identified problem may be confirmed by future data. For example, problems may only be reported after they have been confirmed one or more times, over a set period of time, and perhaps before and after a cleaning event, which would clear faults due to soiling, but not those due to hard faults. Thus, in some embodiments, watch lists may be used for identified problems as a way to store them for repeated analysis in order to avoid maintenance alerts that are not warranted, or based on incomplete or erroneous diagnosis.

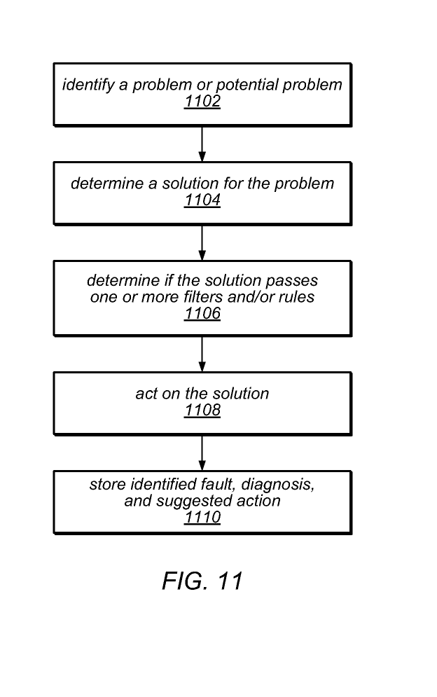

The method may also apply various filters to the determined problems, e.g., before they are acted on or passed on to users, as described below in FIG. 11. For example, there may be a threshold (e.g., set by a user) which specifies that analysis should only be performed for panels performing less than a threshold amount (e.g., 10% less than other panels in a same area or string, 10% less than versus prior measurement data, etc.). The filters may generally be used to weed out false alarms or alarms that are not very meaningful (e.g., a 2% decrease in solar panel output may not indicate a problem that should be addressed). Because solar power systems are generally very noisy in their output (e.g., patterns are often hard to determine due to the naturally high degree of variance in solar irradiation of panels), only identifying problems that are addressable (and therefore real) and are not false alarms may be very important, so that users associated with the solar system do not ignore the alarms that are provided and can be sure that they are real.

The identification of a problem may indicate a possible cause (e.g., using the impairment models described above) to the problem or may simply indicate that human interaction or further analysis is required. For example, the determined problem may be that the one or more of the solar panels are soiled (e.g., from pollen, refuse from birds, debris, etc.) or it may be that there is a malfunction of one or more solar panels (e.g., where impairment models do not identify a probable cause). Thus, the problem identified in 1010 may indicate a source of the problem or may simply indicate that a problem exists for further analysis, as desired.

### FIG. 11—Acting on Identified Problems

FIG. 11 illustrates a method for acting on identified problems, such as those identified in FIG. 10. The method shown in FIG. 11 may be used in conjunction with any of the computer systems or devices shown in the above Figures, among other devices. For example, FIG. 11 may correspond to an embodiment of a method performed by the various blocks shown in FIG. 6. In various embodiments, some of the method elements shown may be performed concurrently, in a different order than shown, or may be omitted. Additional method elements may also be performed as desired. As shown, this method may operate as follows.

In 1102, a problem (or potential problem) may be identified (e.g., using the method of FIG. 10).

In 1104, the method may determine (e.g., automatically) a suggestion for addressing the problem. The solutions for various problems may be already stored in a solutions database. For example, there may be a known solution for soiled solar panels (e.g., notify a user to clean the solar panels, automatically provide a request for a cleaning, such as to a maintenance company, etc.). Similarly, there may be a known solution for a faulty solar panel (e.g., request maintenance of the solar panel, ship the solar panel back to manufacturer, etc.). Accordingly, the method may automatically determine a solution (or multiple possible solutions) for a problem using a database associating problems with solutions.

Where multiple solutions are possible, the method may automatically select one of the solutions, e.g., using one or more rules. For example, if a panel is malfunctioning and the solutions are to 1) request maintenance of the panel or 2) ship the panel back to the manufacturer, the method may automatically select one of the options based on various data. For example, the method may choose to ship the panel back to the manufacturer of the panel is still under its warranty (e.g., whose date may be stored in the configuration database).

In some embodiments, the solutions may be determined in response to user input (e.g., selecting one solution from a plurality of solutions, such as by using the user portal described above), by the user actually specifying a solution (e.g., specifying that a maintenance company should be called), etc. Thus, while the solutions may be automatically identified, in some embodiments, user's input may also be involved.

In 1106, the method may determine if the solution (or the identified problem) passes one or more filters or rules. For example, there may be business rules associated with performing a solution. More specifically, a problem or solution may not be implemented or acted upon if the problem does not impact power output by a significant amount (e.g., if power output is still operating at a threshold amount, e.g., 95% or better, if the impact is less than a threshold amount, such as 2%, 5%, etc.). As another example, the problem or solution may not be acted upon if the cost is greater than a threshold amount, if the benefit is less than a threshold amount (e.g., in dollars or power), if the cost to benefit ratio does not exceed a threshold amount, etc.

In one embodiment, the method may use other information, such as maintenance information, to determine whether the solution should be acted upon. For example, if the identified problem is soiling, and the solution is to clean the solar panels, the method may determine that a previously scheduled cleaning will happen in the next week. Accordingly, the method may simply ignore the problem since a cleaning will occur regardless, based on the maintenance plan. As another example, warranty information may be used to determine whether to act on a solution. For example, because shipping a solar panel is expensive, the solution to ship back malfunctioning solar panels may only pass the rules once a certain number of solar panels need to be shipped (e.g., to overcome the cost of shipping).

In 1108, the method may act on the suggestion. For example, the method may identify a desired course of action based upon user defined rules for alerts and notification. In one embodiment, the method may notify one or more users of the problem and/or the suggestion. More specifically, in one embodiment, one or more users associated with the solar panels may be stored, e.g., in a database. For example, various communication method(s) may be associated with a user (e.g., email address(es), phone number(s), etc.) and the method may automatically notify the appropriate user(s) of the problem and/or suggestion. In some embodiments, users may be selectively notified. For example, if a solution exceeds a threshold amount of money, a manager or financial user may need to be notified in order for the problem to be resolved (e.g., by approving the suggested solution). Alternatively, a electrical connection issue may be provided to a user associated with electrical connections (e.g., an electrician) whereas a location based issue (such as soiling) may be provided to a user associated with cleaning of the solar system (e.g., to clean pollen off of the solar panels). Thus, the method may automatically notify users in a selective manner, as desired.

Alternatively, the method may automatically implement the suggestion, if possible. For example, if the solution is to clean the solar panels, the method may automatically send a request to a cleaning company to clean the solar panels. As another example, the method may automatically request maintenance for a maintenance company when a combiner is determined to be malfunctioning. Similar to above, the automatic implementing of a solution may be determined based on rules. For example, the solution may be automatically implemented if it costs less than a threshold amount, if the benefit is greater than a certain amount (e.g., in dollars or power), if the cost benefit ratio exceeds a ratio, etc. Where these thresholds are not reached, user approval may be necessary, or the solution may be ignored until it is exacerbated or satisfies the rules.

In some embodiments, a solution may not be determined, and the rules may be applied to the identified problem simply to determine whether to alert a user. Thus, instead of determining a solution and determining whether to act on the solution (e.g., by automatically adjusting values, ordering replacement parts, requesting maintenance, reporting to a user, etc.), the method may used simply for notifying users.

In 1110, the method may automatically store the identified fault, diagnosis, suggested remedial action, and notification action, e.g., in a maintenance log, accessible to the site owner and authorized designees, such as security, the maintenance company, or the designated cleaning company. The faults and suggested action may then be kept visible until the action is complete and the authorized user confirms that the fault has been cleared. In some cases, it may be determined that the fault could not be cleared, e.g., if the reduction in power has been caused by a new building construction adjacent to the array. In this case, the user can commit the knowledge of the new construction into the configuration database, thus designating the fault condition as a known fault that is not to be flagged in the future

The method may provide for this log to be archived as a complete history of fault diagnosis and maintenance. This may be of value in collecting patterns of similar faults, setting budgets for future maintenance events, discussing performance with financial backers or insurance companies, etc.

While the descriptions above regarding FIG. 11 generally relate to attempting to solve detected issues, these issues may additionally, or alternatively, be provided to the user. For example, one or more reports (e.g., including individual or compilations of identified issues or other information) may be stored and/or provided to the user, as desired. These reports may direct attention to identified impairments and may include prioritization of detected or inferred impairments generated based on business analysis (e.g., such as those discussed above).

In one embodiment, the method may provide an indication of any issues by providing a spatial map model of the array, e.g., including representations for elements within the PV system and visual indications of performance within the system on the spatial map. For example, the visual indications may indicate any of the detected impairments or even application of the business rules discussed above. The visual indications may include use of color. Further, spatial performance information may be “played back” using a time series of data and/or may be toggled between different levels of hierarchy, as desired.

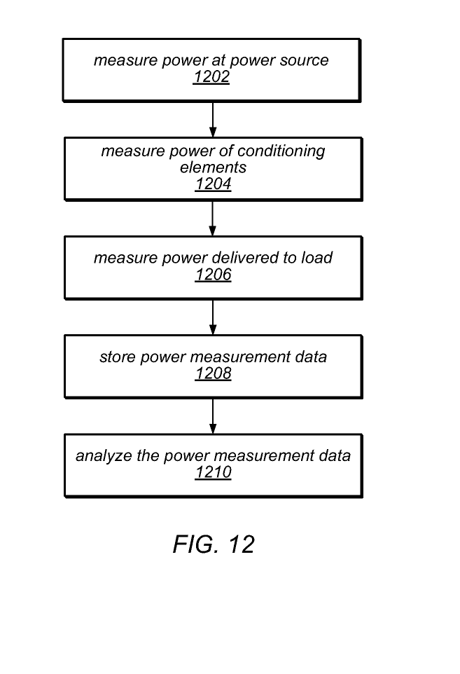

### FIG. 12—Power Performance Analysis

FIG. 12 illustrates a method for performing power performance analysis. The method shown in FIG. 12 may be used in conjunction with any of the computer systems or devices shown in the above Figures, among other devices. In various embodiments, some of the method elements shown may be performed concurrently, in a different order than shown, or may be omitted. Additional method elements may also be performed as desired.

A substantial aspect of a power system performance analysis may be directed toward the determination of proper operation and identification of impairments which are actionable to bring power levels to optimal conditions. Such performance analysis may be significantly improved when all aspects of the power flow path are monitored, including the source of power, the wiring, power conditioning and conversion units, and the delivered power. For a PV system this may involve monitoring the solar panels themselves, the input DC and output AC of the inverter(s), and the AC power delivered to the load or grid, and may optionally or alternately include monitoring the strings of panels at the combiner box.

The performance analysis system may thus compare the power levels at each location in the power flow path and deduce the losses in each element, indicating potential impairments in the system, and may further monitor those losses over time to indicate degradation of elements within the system.

The analysis system may capture data from the sensors within the system, store it is a database with knowledge of logical and physical correlations, process the data as time streams, and may apply post-processing analysis. The result of analysis may then be sorted and prioritized for indication to the user based upon business rules associated with cost of power and cost of repair of correction of the impairments indicated.

As shown, this method may operate as follows.

In 1202, PV system electrical performance may be performed as close to the source of power as is practical or financially justifiable. For example, this measurement of power may include the use of sensor nodes attached to PV modules within the array, e.g., at each panel. Alternatively, or additionally, this measurement may include the use of sensors attached to string wiring within a multi-string combiner box unit. Said another way, the measurement may include power measurements at the string level.

In one embodiment, the source measurement sensor may include time interval processing that may include resampling, accumulation, and/or processing of data at various time intervals. This may allow for the transmitted measurement data time interval to be selectable and at longer intervals than the actual measurement sample interval.

In 1204, the method may measure the power flow conditioning elements. For example, the power flow conditioning elements may include DC-to-AC inverters, measurement of electrical data on the DC of the inverter, etc.

In 1206, the power delivered to the load may be measured. For example, this measurement may involve the measurement of AC power delivered into an AC distribution system, such as an AC transmission grid.

In 1208, the power measurement data may be stored, e.g., within a database. The power measurement data may be stored in any of the databases discussed above, among others, e.g., in the manner described above, although other embodiments are envisioned.

In 1210, the power measurement data may be analyzed to provide information targeted toward maintaining high (e.g., optimal) performance of the PV system. The analysis of the measurement data may include processing of data as time streams, as well as time interval resampling, accumulation, and/or processing of data at various time intervals. In one particular embodiment, the analysis of data may be dynamic and performed during the time interval resampling process. Alternatively, or additionally, the data analysis may be performed as a post-processing function, at a programmed interval, e.g., which is larger than the base time interval within the data. The time interval data may be analyzed to provide indications of impairments within the PV system, e.g., as discussed above. The indications of impairments may be correlated to the physical and/or logical configuration of the PV system. The impairment identifications may be made available for directed maintenance of the PV system.

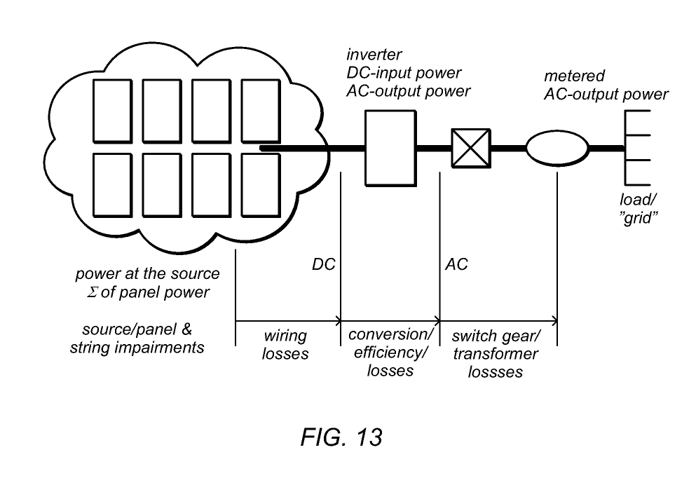

FIG. 13 is an exemplary Figure illustrating the various points where power may be measured as well as various possible losses.

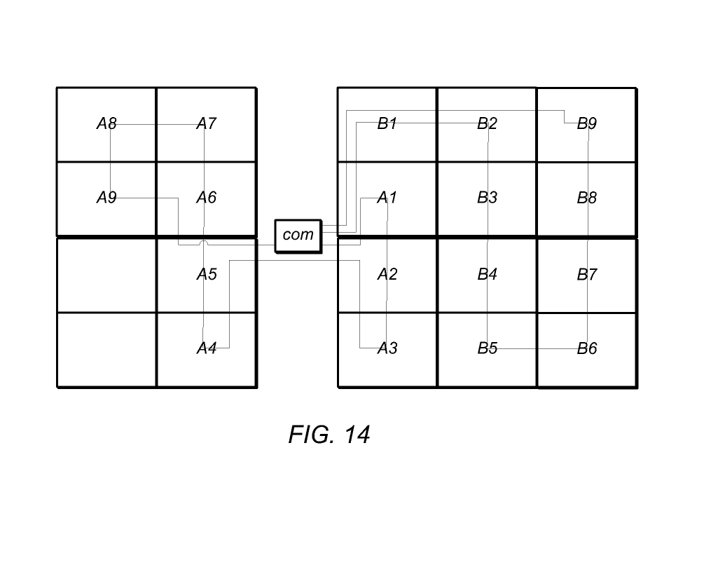

### FIGS. 14-16—Diagrams Illustrating Exemplary Embodiments

FIGS. 14-16 are diagrams illustrating specific embodiments of the systems and methods described above. These embodiments are exemplary only and are not limiting.

More specifically, FIG. 14 is an exemplary diagram illustrating both the physical and logical configuration of a solar panel array, such as one place on a roof or on a car port. The diagram of FIG. 14 may be created using the physical information and the logical information described above. In alternate embodiments, a physical diagram (showing the physical layout) and a separate logical diagram (showing the logical layout) may be generated.

As shown by the connectivity of the solar panels in FIG. 14, solar panels A1-A9 are in a common string and solar panels B1-B0 are in a common string. In more detail, A1-A9 (which may represent the monitors or optimizers of each panel) are connected in series and the terminal ends are connected to the combiner. Similarly, B1-B9 are connected in series and the terminal ends are connected to the combiner. However, the physical layout of the panels are distinct and unique from the logical connectivity shown. In more detail, panels A4-A9 are on one side of the combiner (with two blank slots of the 2×4 layout) and panels A1-A3 are on the other side of the combiner, in a different section. Panels B1-B9 are in the same section as panels A1-A3. Thus, in the exemplary physical and logical configuration shown in FIG. 12, a piece of localized shade that touches panels A3 and B5 would affect two different strings, yet the same degree of shade hitting B5 and B6 would affect only one. Thus, the ability to identify both physical and logical layouts and the ability to analyze and diagnose using both forms (in addition to temporal tracking) may allow the methods herein to diagnose array faults in a more precise and intelligent manner than was previously available.

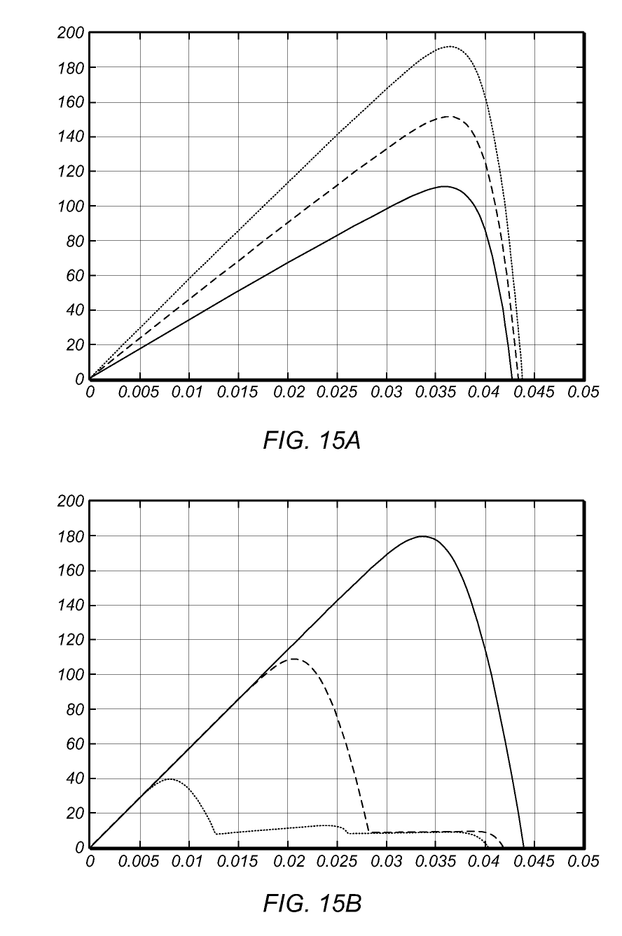

FIGS. 15A and 15B illustrate characteristic plots for panels having impairments or issues (e.g., as produced by the impairment models described above). More specifically, FIG. 15A illustrates power versus voltage for varying irradiance, e.g., due to localized impairments by soft shade (such as from cloud cover, distant objects, etc.) or by mild soiling (such as from pollen, dust, etc.). FIG. 15B illustrates power versus voltage for snapped diode conditions, e.g., induced by physical damage within the panel or by localized hard shade (such as close in objects, hard soiling, such as leaves, bird droppings, etc.). Thus, the two panel output graphs shown in FIGS. 15A and 15B indicates that differentiating between impairments is possible by using the information available at the inputs of a panel optimizer or monitor and that first order automatic diagnosis of panel and strings faults is therefore possible, as discussed above.

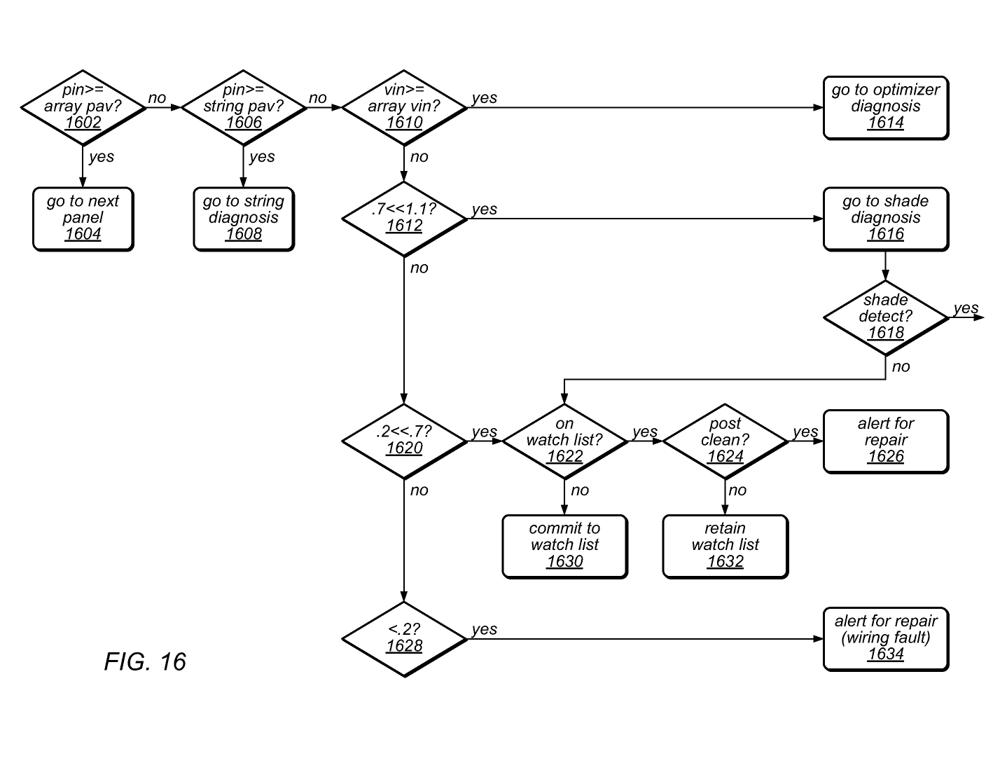

FIG. 16 is an exemplary flowchart for performing panel diagnosis. In the flowchart of FIG. 16, the data used for comparison may be for a defined time period depending on the purpose of the analysis. In one embodiment, a 15 minute data run from early morning, noon, and early evening may be used to detect panel faults versus shading issues. In the embodiment shown, Pin=power from panel detected at optimizer input, Array Pay=average Pin across the array, String Pay=average Pin for the string with this panel, Vin=Voltage at the optimizer input, and Array Vin=Average Vin for the array.

As shown, in 1602, if the power from the selected panel is greater than or equal to the average power per panel of the array, then the next panel is selected in 1404, otherwise the method continues to 1606.

In 1406, if the power from the selected panel is greater than or equal to the average power per panel of the string, then the method continues to a string diagnosis in 1408. If not, the method continues to 1610.

In 1610, if the voltage from the selected panel is greater than or equal to the average voltage for the array, then the method continues to optimizer diagnosis in 16414. If not, the method continues to 1612.

In 1612, if the voltage from the selected panel is between 0.7 and 1.1, then the method continues to shade diagnosis in 1616, which may determine if there is a shade detection in 1618. If so, the method may continue for further diagnostics, if not, there may be determination if the panel or fault is on the watch list in 1622. Returning back to 1612, if the voltage from the selected panel is not between 0.7 and 1.1, the method may continue to 1620.

In 1620, if the voltage from the selected panel is between 0.2 and 0.7, then the method may continue to 1622 to determine if the panel or problem is on a watch list. If not, in 1628, the method may determine if the voltage of the selected panel is less than 0.2, in which case an alert may be sent for repairing the panel (e.g., for a wiring fault) in 1634.

Returning to 1622, if the panel or problem is not on a watch list, then it may be added in 1630. If it is, then there may be a determination if the panel is cleaned (or will soon be cleaned) in 1624. If not, the panel or problem may be retained on the watch list in 1634. If so, an alert for repair of the panel may be sent in 1626.

Note that the various thresholds and numbers described above are exemplary only and other numbers or embodiments are envisioned. Similarly, the method shown in FIG. 16 is shown for exemplary purposes only and other heuristics and diagnostic procedures may be performed.

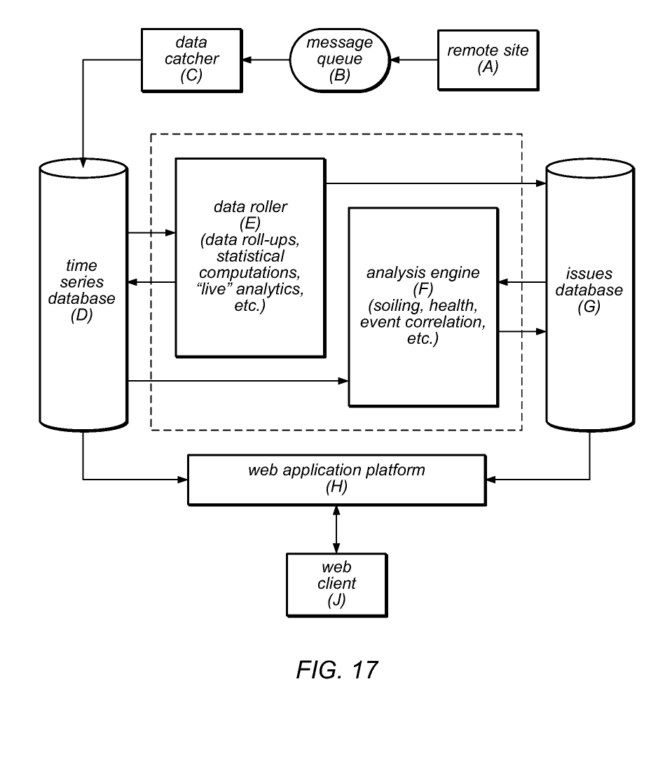

### FIG. 17—Exemplary Data Flow

FIG. 17 is an exemplary diagram corresponding to data flow in an exemplary PV system.

In the embodiment of FIG. 17, data may collected from the Remote Site A and made available to subscribers of that data via Message Queue B. Note that the data from Remote Site A may be compressed or otherwise in need of preprocessing (e.g., adding timestamps to incoming data, if necessary), which can be performed either before or after Message Queue B. A typical subscriber to the data stream from Message Queue B is Data Catcher C, which may store the raw data in Time Series Database D. The processing subsystem is shown in the dotted box (comprising Data Roller E and Analysis Engine F), and may be implemented as one or more processes or threads running on one or more computers, processors, or cores. Subsequent processing may result in the creation of new data to be stored in Time Series Database D and Issue database G. Although these two databases could in principle be the same, the differing performance profiles required for each application will likely cause a preferred embodiment to use a database optimized for fast column and row operations for the Time Series Database D, and a more conventional relational database for the Issues Database G.

At predetermined programmable intervals, or when alerted to incoming data, Data Roller E may process newly arrived data by performing “rollup” operations to create “cubes” of preprocessed data for one or more time periods (e.g., condensing multiple data points into a one or more values representative of the entire interval). In the preferred embodiment, Data Roller E may perform rollups at a variety of useful intervals, such as five minutes, fifteen minutes, one hour, one day, etc. In performing the rollups over time periods, Data Roller E may also pre-compute and add to the resulting cubes a variety of useful statistical parameters for each rollup period to speed subsequent processing. Examples of such statistical parameters include, but are not limited to, sum, count, mean, maximum, minimum, sum of squares, root mean square, and standard deviation. The resulting cubes may be stored back into Time Series Database D by Data Roller E for subsequent use by other elements of the system. In addition, Data Roller E may contain processing algorithms to observe and detect some types of errors and problem conditions, triggering the creation of issues to be stored in Issues Database G.

Analysis Engine F may periodically or programmatically perform higher level analyses on the data in the rolled up cubes provided by Time Series Database D. This analysis may include soiling analysis, the health of the array as a whole or any of its constituent elements, correlation of data signals across data elements, time, location in the array, or other types of analysis. In performing these higher level analyses, Analysis Engine F may also pull issues from Issues Database G to provide correlation and consolidation of issues (e.g., to recognize that issues showing no power production for all panels on a string are actually related and caused by a single failure on the string, such as a blown fuse). This secondary issues analysis may include the use of data from Time Series Database D in addition to the issues data from Issues Database G. Analysis Engine F may then update Issues Database G with the properly consolidated issue data.

Web Application Platform H may serve data from Time Series Database D and Issues Database G properly transformed for display, reporting, and visualization via a standard web browser on Web Client J.

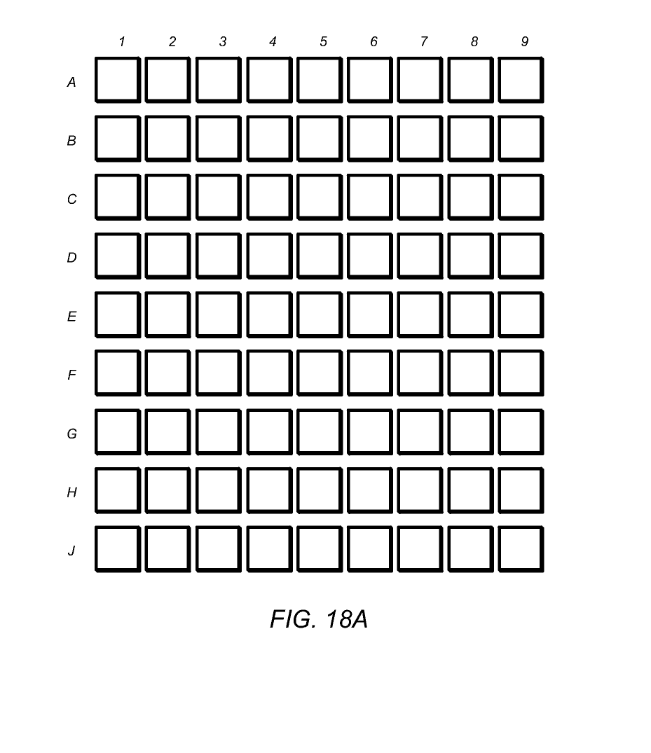

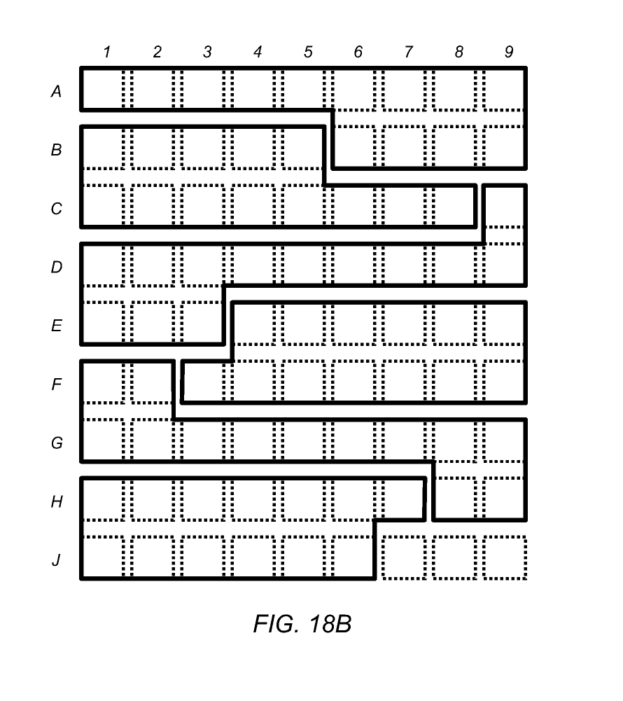

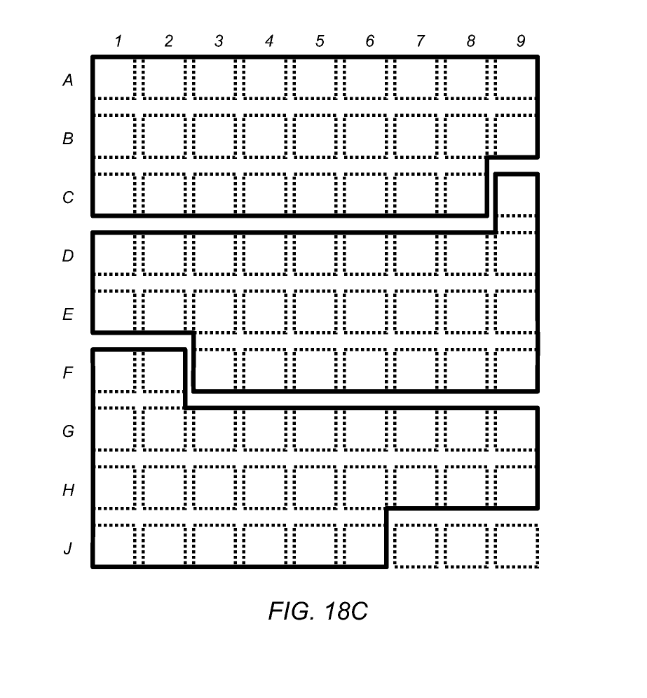

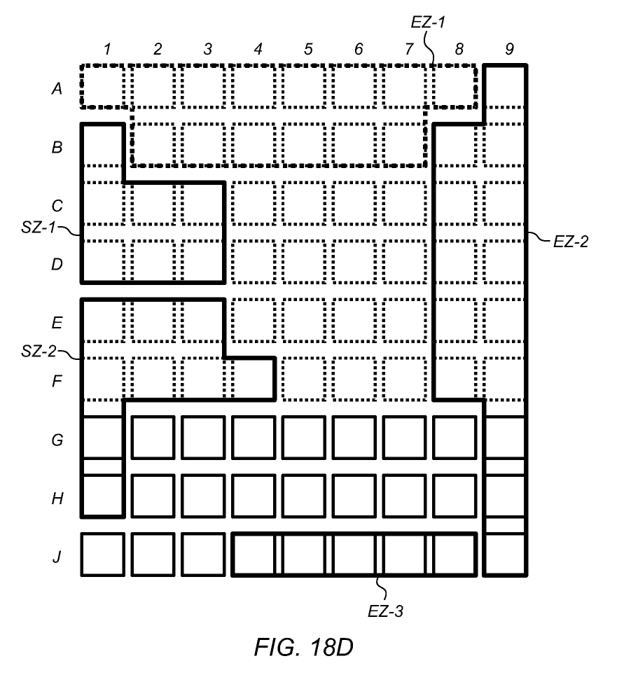

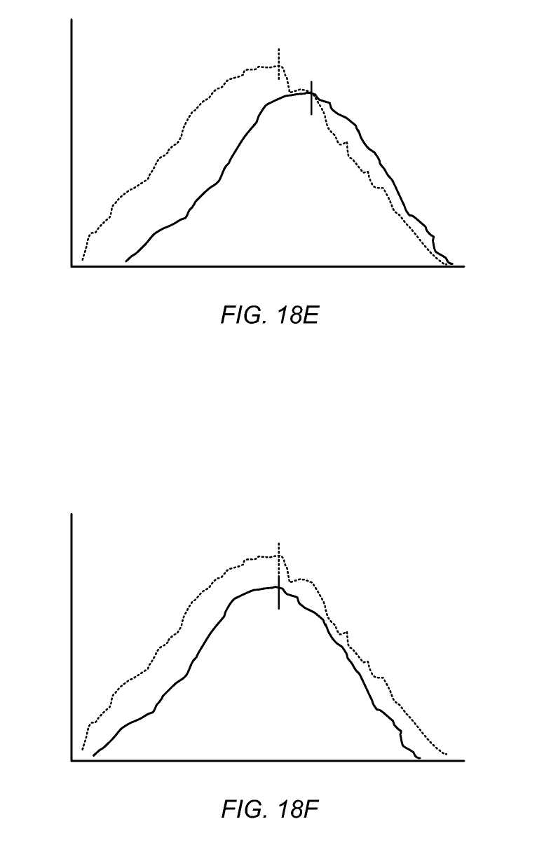

### FIGS. 18A-18F—Exemplary Data Visualization

FIG. 18A-18E are exemplary diagrams corresponding to data visualization in an exemplary PV system.

Visualization of large datasets presents difficulties in ensuring that the presentation of data is intuitive, relatable, and apprehensible. In one embodiment, the application may serve (e.g., from the cloud) a set of map-based representations of the array based on status information, measured information, modeled information, or any desired combination.

In FIG. 18A, a small typical subset of a solar array is shown. In this example, photovoltaic solar panels are located at each of the grid intersections designated by rows A-J and columns 1-9. Note that the elements shown in this case are individual solar panels, the most granular level possible in this example.

In this example, the array includes strings each comprising 13 solar panels, as shown in FIG. 18B. String 1 is made up of panels A-1, A2, A-3, A-4, A-5, A-6, A-7, A-8, A-9, B-9, B-8, B-7, and B-6. Similarly, String 2 comprises panels B-5, B-4, B-3, B-2, B-1, C-1, C-3, C-3, C-4, C-5, C-6, C-7, and C-8. Other strings are designated from successive groups of 13 panels in similar fashion as shown. This type of aggregation has a number of benefits, including that it allows grouping of elements of the array (in FIG. 18B, individual panels) into larger groups that may reflect a hierarchy of function.

As shown in FIG. 18C, this hierarchical grouping may be extended to arbitrary levels to encompass larger groups as necessary, such as combiners, inverters, etc. In this example, the strings shown in FIG. 18A are further grouped into groups of two strings, which might represent a string combiner, or perhaps a small string inverter. For the purposes of this description, assume that the two string groupings each correspond to a two-string inverter. As shown, Inverter INV1 comprises String 1 and String 2, Inverter INV2 comprises Strings 3 and 4, and so on.

Reducing the number of elements shown on the screen through such hierarchical groupings may be desirable, (and even necessary) in some implementations, to allow the web client to effectively display information representing a very large number of nodes, such as is likely to be found in a large utility scale solar array. Note that it is not necessary for these groupings to be contiguous, and in fact, it is often necessary for them to accommodate discontinuities in order to correctly reflect the physical and electrical structure of the array.

In addition to groupings based on logical hierarchy, other groupings may be desirable to allow visualization of various status or performance metrics corresponding to other groupings, such as the geographically determined zones shown in FIG. 18D. In this figure, edge zones EZ-1, EZ-2, and EZ-3 have been defined to more easily allow visualization of effects such as zonal soiling near the edges of the array. Further, Zones SZ-1 and SZ-2 have been created to show afternoon shading, perhaps from nearby trees or other irremedial shade producers. Such grouping zones may be created manually, automatically, or semi-automatically as arbitrary groups of panels to correspond to physical impairments affecting the array, such as shading or soiling, logical groupings that may not necessarily be reflected in the basic logical hierarchy of the array as shown in the figures above (e.g., groups comprising a particular type of solar panel in an array consisting of mixed panel types), physical placement of groups in the array, or groupings based on measured or calculated performance criteria (e.g., panels affected by early winter seasonal shading). Note that automatic creation of such groups may allow an intelligent array analysis engine to create such groups on an ad hoc basis as needed to aggregate elements of the array that share certain performance, fault, or other characteristics.

Once any of the types of groupings described above have been created (including that of FIG. 18A, showing individual elements), they may be used as an aid to visualize both qualitative and quantitative information about the array corresponding to those groupings. In one embodiment, the color of the element or group may be used to indicate performance of that element by specific criteria. Examples of the types of information thus visualized include, but are not limited to, absolute performance, relative performance, performance normalized to particular conditions (e.g., incoming solar irradiance, temperature, etc.), performance against models, plans or projections, status of the element (e.g., known, detected, or suspected faults or impairments), etc.

In addition to or in place of color, other visualization methods may be used to indicate quantitative or qualitative information regarding the element or group, for instance, a three dimensional graph (e.g., 3D column or surface mesh) or stacked line or bar graphs might be used to visualize the power or energy output of panels or strings in an array.

Further, these visualization methods may be extended to allow the visual indication to show change over an additional axis such as time. In one embodiment, color-indexed visualizations of various status and performance metrics may be animated over time, and even associated with a variety of timeline or other time indicating controls to allow interactive exploration of the state of the array from a variety of informational perspectives at a particular time or over a period of time that is of interest.

The comparison of time related data with respect to the apparent daily and seasonal motions of the sun (as in solar array monitoring) presents challenges not often encountered in more ordinary presentations of time related data. This is because the apparent motion of the sun in the sky is based on a somewhat complex interrelationship of the earth's orbital eccentricity, its axial tilt relative to its orbital plane, and the observer's location on the planet, among other less important factors. The effect of these interrelated motions is a variation between clock time and solar time known as the equation of time, which can be used to transform clock time to observed solar time or vice versa. (The equation of time, and its graphical representation, the analemma, is frequently shown on working sundials and on globes to allow the user to correlate observed solar time and clock time.) This variation, which is quite sizeable seasonally (roughly a full fifteen minutes fast or slow, depending on the time of year, varying in a roughly double sine wave), has the property of confounding comparisons of data from one part of the year to another, since any kind of solar derived data from one date (based on any time zone's clock time) will not (except by occasional accident) be properly synchronized with that from another date or location.

In one embodiment of the data visualization system, data from disparate times and/or locations may be may be adjusted and displayed to provide a more relevant comparison. This may be accomplished through several mechanisms, one of which is to simply shift the graphical representations along the time axis so that solar noon is aligned in all of them. In addition, there are circumstances in which it may be desirable to also eliminate the effects of the changing length of days—in these cases, aligning the data from various graphs at solar noon may not be sufficient, and the graphs may be scaled so that sunrise and sunset also align to give a more comparable, if less accurate, relative to clock time, picture of performance relative to the sun.

FIG. 18E shows an example of an overlaid graph of solar power production from two days at different times of the year, illustrating the problem of trying to directly compare performance characteristics based on the motion of the sun in static clock time.

FIG. 18F illustrates the improvement obtained in interpreting the solar power production data from the two days by aligning solar noon, thus more easily allowing a direct comparison.

### Advantages

Embodiments described herein may provide the following advantages over prior systems:

Ability to commission a PV solar power array at install and re-commission during operation, to maximize energy output by compensating for impairments due to panel damage, shading, temperature variations or other environmental factors, by modifying the operating firmware and target parameters for every solar panel in the array.

Creation of a database capturing the current physical assets and configuration of a PV solar power array, enabling calculation of ideal reference performance models and the ability to detect and calculate the impact of impairments to performance.

Automatic creation of physical (spatial) and logical (circuit) maps of PV solar arrays and the use of these models in combination and over time to identify, analyze and diagnose array impairments.

Automatic identification and diagnosis of impairments in PV solar power arrays during operation, by collecting and analyzing the performance characteristics at the individual panel level and comparing the resulting temporal and spatial patterns to known impairment models.

Method for implementing business rules, thresholds and allowance for known site issues in the form of automatic filters that help define the priority and importance of automatically generated performance, impairment and safety notifications. This maximizes the value of the notification and alert system and minimizes the creation of ‘false’, ‘non-actionable’ or ‘frivolous’ alarms

Automatic creation of site maintenance plans conditioned by defined business rules, including detail of suggested remedial action.

Provision of remotely accessed drill-down diagnostics at the PV panel, string and sub-array level to validate root cause analysis and suggested remedial action

Continuous adaptation of PV array ‘ideal’ and ‘expected’ performance models based on site learning (e.g., daily shading, seasonal factors, planned events), known ageing effects and continually updated for performed repairs and upgrades plus regularly scheduled maintenance (e.g., cleaning).

Automatic calculation of energy impact of identified impairments, allowing business thresholds to be set for maintenance notifications.

Creation of a database that captures both the physical (spatial/geographic) and logical (circuit/hierarchy) structure of the array and allows analysis of data at any hierarchy level to be compared to physical or logical analogs to detect performance outliers and/or anomalies.

Using spatial maps (which themselves may be elements of a hierarchical structure) augmented with embedded encoding of logical structures (for example, grouping a set of optimizers or panels in an SVG/XML map as a “string”, and the string as part of a higher-level “combiner/bus” or “inverter” group) to drive database creation and updates for array commissioning or reconfiguration.

Using logical structures and physical location information stored in a database to drive creation and modification of the spatial maps and their embedded encoding of logical information as well as physical layout. This database information can also be used to drive array commissioning or reconfiguration.

Bidirectional information mappings and flow between the database containing logical/physical information and the spatial maps with embedded logical structure encoding, allowing changes in either to propagate to and update the other.

Although the embodiments above have been described in considerable detail, numerous variations and modifications will become apparent to those skilled in the art once the above disclosure is fully appreciated. It is intended that the following claims be interpreted to embrace all such variations and modifications.

We claim:

1. A method for automatically determining issues associated with a photovoltaic (PV) system, the method comprising:
utilizing a computer system to perform:
storing information regarding the PV system, wherein the information comprises logical information regarding a logical configuration of the PV system and physical information regarding a physical layout of the PV system;
receiving measurement data regarding the PV system;
automatically analyzing the measurement data regarding the PV system, wherein said analyzing comprises utilizing the logical information and the physical information,
automatically providing an indication of any issues determined by said analyzing.

2. The method of claim 1,
wherein said storing information regarding the PV system comprises automatically obtaining information regarding the logical configuration and the physical layout of the PV system.

3. The method of claim 1,
wherein said storing information regarding the PV system comprises receiving information regarding the PV system from a device operated by a user.

4. The method of claim 3,
wherein the device comprises GPS circuitry and/or a barcode scanner to assist in providing the information.

5. The method of claim 1,
wherein said receiving measurement data regarding the PV system comprises the computer system receiving the measurement data over a wide area network, wherein the computer system is coupled to the PV system over the wide area network.

6. The method of claim 1, further comprising:
storing a model which describes a projected performance of the PV system based on the information regarding the logical configuration of the PV system;
wherein said automatically analyzing uses the model.

7. The method of claim 1, further comprising:
storing a model which describes a projected performance of the PV system based on the information regarding the logical configuration of the PV system and the physical layout of the PV system;
wherein said automatically analyzing uses the model.

8. The method of claim 1,
wherein said automatically analyzing comprises comparing the received measurement data with an expected operation of the PV system.

9. The method of claim 8, wherein the expected operation of the PV system is based on environmental conditions and losses due to impairments in the PV system.

10. The method of claim 8, wherein the expected operation is based on environmental conditions, geographical location, and seasonal variance data.

11. The method of claim 1,
wherein said automatically analyzing comprises performing pattern matching to identify known patterns in the received measurement data regarding the PV system.

12. The method of claim 11, wherein the pattern matching is based on the logical configuration of the PV system.

13. The method of claim 1,
wherein said automatically analyzing comprises comparing the received measurement data with statistical information of past measurement data to determine anomalies in the received measurement data regarding the PV system.

14. The method of claim 1,
wherein said automatically analyzing comprises determining changes in the received measurement data over time.

15. The method of claim 1,
wherein said automatically analyzing comprises determining:
1) a rate of change (first derivative) of one or more parameters in the received measurement data; and
2) a rate of rate of change (second derivative) of one or more parameters in the received measurement data.

16. The method of claim 1,
wherein said receiving measurement data regarding the PV system and said automatically analyzing the measurement data regarding the PV system are iteratively performed.

17. The method of claim 16, wherein said automatically analyzing comprises:
extrapolating one or more trends from the iterative measurement data to project PV system performance; and
comparing the measurement data to the projected PV system performance.

18. The method of claim 1,
wherein said storing information comprises storing information regarding characteristics of the components of the PV system.

19. The method of claim 18, wherein the characteristics include:
physical information;
electrical information; and
unique identifying information for a plurality of components of the PV system.

20. The method of claim 1, further comprising:
storing a rules engine which provide rules for messaging alerts;
wherein said automatically providing an indication of any issues determined by said analyzing is performed according to the rules engine.

21. The method of claim 1, further comprising:
automatically adjusting operation of the PV system based on said automatically analyzing.

22. A non-transitory, computer accessible memory medium storing program instructions for automatically determining issues associated with a photovoltaic (PV) system, wherein the program instructions are executable to:
store information regarding the PV system, wherein the information comprises logical information regarding a logical configuration of the PV system and physical information regarding a physical layout of the PV system;
receive measurement data regarding the PV system;
automatically analyze the measurement data regarding the PV system, wherein said analyzing comprises utilizing the logical information and the physical information,
automatically provide an indication of any issues determined by said analyzing.

23. The non-transitory, computer accessible memory medium of claim 22,
wherein said storing information regarding the PV system comprises automatically obtaining information regarding the logical configuration and the physical layout of the PV system.

24. The non-transitory, computer accessible memory medium of claim 22,
wherein said storing information regarding the PV system comprises receiving information regarding the PV system from a device operated by a user.

25. The non-transitory, computer accessible memory medium of claim 24,
wherein the device comprises GPS circuitry and/or a barcode scanner to assist in providing the information.

26. The non-transitory, computer accessible memory medium of claim 22,
wherein said receiving measurement data regarding the PV system comprises the computer system receiving the measurement data over a wide area network, wherein the computer system is coupled to the PV system over the wide area network.

27. The non-transitory, computer accessible memory medium of claim 22,
wherein said automatically analyzing uses a model which describes a projected performance of the PV system based on the information regarding the logical configuration of the PV system.

28. The non-transitory, computer accessible memory medium of claim 22,
wherein said automatically analyzing uses a model which describes a projected performance of the PV system based on the information regarding the logical configuration of the PV system and the physical layout of the PV system.

29. The non-transitory, computer accessible memory medium of claim 22,
wherein said automatically analyzing comprises comparing the received measurement data with an expected operation of the PV system.

30. The non-transitory, computer accessible memory medium of claim 29,
wherein the expected operation of the PV system is based on environmental conditions and losses due to impairments in the PV system.

31. The non-transitory, computer accessible memory medium of claim 29,
wherein the expected operation is based on environmental conditions, geographical location, and seasonal variance data.

32. The non-transitory, computer accessible memory medium of claim 22,
wherein said automatically analyzing comprises performing pattern matching to identify known patterns in the received measurement data regarding the PV system.

33. The non-transitory, computer accessible memory medium of claim 22,
wherein the pattern matching is based on the logical configuration of the PV system.

34. The non-transitory, computer accessible memory medium of claim 22,
wherein said automatically analyzing comprises comparing the received measurement data with statistical information of past measurement data to determine anomalies in the received measurement data regarding the PV system.

35. The non-transitory, computer accessible memory medium of claim 22,
wherein said automatically analyzing comprises determining changes in the received measurement data over time.

36. The non-transitory, computer accessible memory medium of claim 22, wherein said automatically analyzing comprises determining:
1) a rate of change (first derivative) of one or more parameters in the received measurement data; and
2) a rate of rate of change (second derivative) of one or more parameters in the received measurement data.

37. The non-transitory, computer accessible memory medium of claim 22,
wherein said receiving measurement data regarding the PV system and said automatically analyzing the measurement data regarding the PV system are iteratively performed.

38. The non-transitory, computer accessible memory medium of claim 37, wherein said automatically analyzing comprises:
extrapolating one or more trends from the iterative measurement data to project PV system performance; and
comparing the measurement data to the projected PV system performance.

39. The non-transitory, computer accessible memory medium of claim 22,
wherein said storing information comprises storing information regarding characteristics of the components of the PV system.

40. The non-transitory, computer accessible memory medium of claim 39, wherein the characteristics include:
physical information;
electrical information; and
unique identifying information for a plurality of components of the PV system.

41. The non-transitory, computer accessible memory medium of claim 22, wherein the program instructions are further executable to:
store a rules engine which provide rules for messaging alerts;
wherein said automatically providing an indication of any issues determined by said analyzing is performed according to the rules engine.

42. The non-transitory, computer accessible memory medium of claim 22, wherein the program instructions are further executable to:
automatically adjust operation of the PV system based on said automatically analyzing.
